(19) United States
(12) Patent Application Publication
(10) Pub. No.: US 2025/0257824 A1
(43) Pub. Date: Aug. 14, 2025

(54) PIPE COUPLING WITH INSTALLATION INDICATOR

(71) Applicant: ASC ENGINEERED SOLUTIONS, LLC, Oak Brook, IL (US)

(72) Inventors: Patrick Chien Chen, North Kingstown, RI (US); Daniel Cross, Wakefield, RI (US); Danielle Grieco, Narragansett, RI (US); Eric John Wanyo, Rumford, RI (US); Charles DiPrima, Newport, RI (US)

(21) Appl. No.: 19/051,571

(22) Filed: Feb. 12, 2025

Related U.S. Application Data
(60) Provisional application No. 63/552,708, filed on Feb. 13, 2024.

(51) Int. Cl. F16L 21/06

(52) U.S. Cl. CPC F16L 21/065; F16L 2201/10

(57) ABSTRACT

A pipe coupling includes a coupling body comprising a first coupling segment and a second coupling segment, each of the first and second coupling segments defining a first end and a second end opposite the first end; a fastener mounted to the coupling body and configured to tighten the pipe coupling from an untightened configuration to a tightened configuration; and an installation indicator arranged between the first end of the first coupling segment and the first end of the second coupling segment, wherein the installation indicator is clamped between the first and second coupling segments in the tightened configuration.

### TECHNICAL FIELD

This disclosure relates to disclosure relates to pipe couplings. More specifically, this disclosure relates to a pipe coupling having an installation indicator to provide a visual indication that the pipe coupling is suitably tightened.

### BACKGROUND

Pipe couplings are commonly used to connect two sections of pipes or other pipe fittings, such as valves, together to form a pipe connection, such as when installing a pipe system or a pipe infrastructure. Some pipe couplings require tightening one or more fasteners to secure the sections of pipes to the pipe couplings. The fasteners typically should be tightened to a desired torque to assure that the clamping force of the pipe coupling provides a reliable seal and/or the pipe section cannot inadvertently separate from the pipe coupling. Thus, improper tightening of the fasteners can result in a failed connection between the pipe sections. However, it can be difficult to know whether the fasteners have been properly tightened. Quality assurance reviews can be made to ensure proper tightening of the fasteners, but such quality assurance reviews can be time consuming and prone to human error.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is pipe coupling comprising a coupling body comprising a first coupling segment and a second coupling segment, each of the first and second coupling segments defining a first end and a second end opposite the first end; a fastener mounted to the coupling body and configured to tighten the pipe coupling from an untightened configuration to a tightened configuration; and an installation indicator arranged between the first end of the first coupling segment and the first end of the second coupling segment, wherein the installation indicator is clamped between the first and second coupling segments in the tightened configuration.

Also disclosed is a pipe coupling comprising a coupling body comprising a first coupling segment and a second coupling segment, each of the first and second coupling segments defining a first end and a second end opposite the first end, wherein; a first indicator element is formed monolithically with the first coupling segment at the first end of the first coupling segment; and a second indicator element is formed monolithically with the second coupling segment at the first end of the second coupling segment; and a fastener mounted to the coupling body and configured to tighten the pipe coupling from an untightened configuration to a tightened configuration, wherein the first indicator element is pressed against the second indicator element in the tightened configuration.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a front view of a pipe coupling comprising an installation indicator, in accordance with one aspect of the present disclosure, wherein the pipe coupling is in an untightened configuration.

FIG. 2 is a cross-sectional view of the pipe coupling of FIG. 1 taken along line 2-2 in FIG. 1.

FIG. 3 is a perspective view of a gasket of the pipe coupling of FIG. 1 comprising the installation indicator.

FIG. 4 is a front view of a pipe coupling of FIG. 1 in a partially tightened configuration.

FIG. 5 is a cross-sectional view of the pipe coupling of FIG. 1 taken along line 5-5 in FIG. 4.

FIG. 6 is a perspective view of the pipe coupling comprising the installation indicator, in accordance with another aspect of the present disclosure, wherein the pipe coupling is in the untightened configuration.

FIG. 7 is a top perspective view of the installation indicator of FIG. 6.

FIG. 8 is a bottom perspective view of the installation indicator of FIG. 6.

FIG. 9 is a cross-sectional view of the pipe coupling of FIG. 6 taken along line 9-9 in FIG. 6, wherein the pipe coupling is in the partially tightened configuration.

FIG. 10 is a detail view of the pipe coupling of FIG. 6 in the partially tightened configuration.

FIG. 11 is a perspective view of the pipe coupling comprising the installation indicator, in accordance with another aspect of the present disclosure, wherein the pipe coupling is in the untightened configuration.

FIG. 12 is a perspective view of the installation indicator of FIG. 11 mounted to a fastener.

FIG. 13 is a detail view of the pipe coupling of FIG. 11 in the partially tightened configuration.

FIG. 14 is a perspective view of the pipe coupling comprising the installation indicator formed monolithically with a coupling body of the pipe coupling, in accordance with another aspect of the present disclosure, wherein the pipe coupling is in the untightened configuration.

FIG. 15 is a perspective view of a coupling segment of the coupling body of the pipe coupling of FIG. 14.

FIG. 16 is a front view of the pipe coupling of FIG. 14 in the partially tightened configuration.

FIG. 17 is a detail view of the pipe coupling of FIG. 14 with at least one side of the pipe coupling in the tightened configuration.

FIG. 18 is a perspective view of the pipe coupling comprising the installation indicator formed monolithically with a coupling body of the pipe coupling, in accordance with another aspect of the present disclosure, wherein the pipe coupling is in the untightened configuration.

FIG. 19 is a perspective view of the pipe coupling comprising the installation indicator, in accordance with another aspect of the present disclosure, wherein the pipe coupling is in the untightened configuration.

FIG. 20 is an end perspective view of the pipe coupling of FIG. 19 in the untightened configuration.

FIG. 21 is an end perspective view of the pipe coupling of FIG. 19 with at least one side of the pipe coupling in the tightened configuration.

FIG. 22 is a perspective view of the pipe coupling of FIG. 19 in a tightened configuration.

FIG. 23 is a perspective view of the pipe coupling comprising the installation indicator, in accordance with another aspect of the present disclosure, wherein the pipe coupling is in the untightened configuration.

FIG. 24 is a detail perspective view of the pipe coupling of FIG. 23 with at least one side of the pipe coupling in the tightened configuration.

FIG. 25 is a perspective view of the pipe coupling comprising the installation indicator, in accordance with another aspect of the present disclosure, wherein the pipe coupling is in the untightened configuration.

FIG. 26 is a top perspective view of the installation indicator of FIG. 25.

FIG. 27 is a bottom perspective view of the installation indicator of FIG. 25.

FIG. 28 is an end perspective view of the pipe coupling of FIG. 25 in the untightened configuration.

FIG. 29 is a perspective view of the pipe coupling comprising the installation indicator, in accordance with another aspect of the present disclosure, wherein the pipe coupling is in the untightened configuration.

FIG. 30 is a perspective view of a coupling segment of the coupling body of the pipe coupling of FIG. 29.

FIG. 31 is a perspective view of the installation indicator of FIG. 29.

FIG. 32 is a perspective view of the installation indicator, according to another example aspect of the present disclosure.

FIG. 33 is an end perspective view of the pipe coupling of FIG. 29 in the untightened configuration.

FIG. 34 is an exploded view of the pipe coupling of FIG. 29.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a pipe coupling and associated methods, systems, devices, and various apparatus. Example aspects of the pipe coupling can comprise an installation indicator for visually indicating that the pipe coupling is suitably tightened. It would be understood by one of skill in the art that the pipe coupling is described in but a few exemplary embodiments among many. No particular terminology or description should be considered limiting on the disclosure or the scope of any claims issuing therefrom.

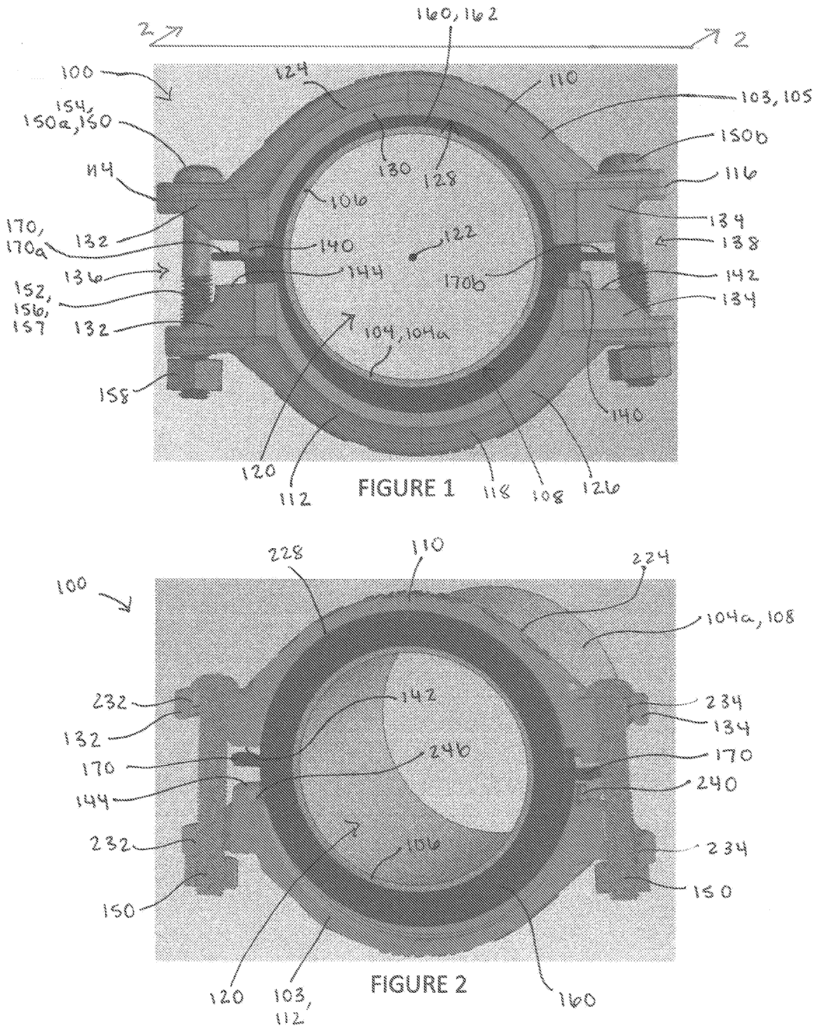

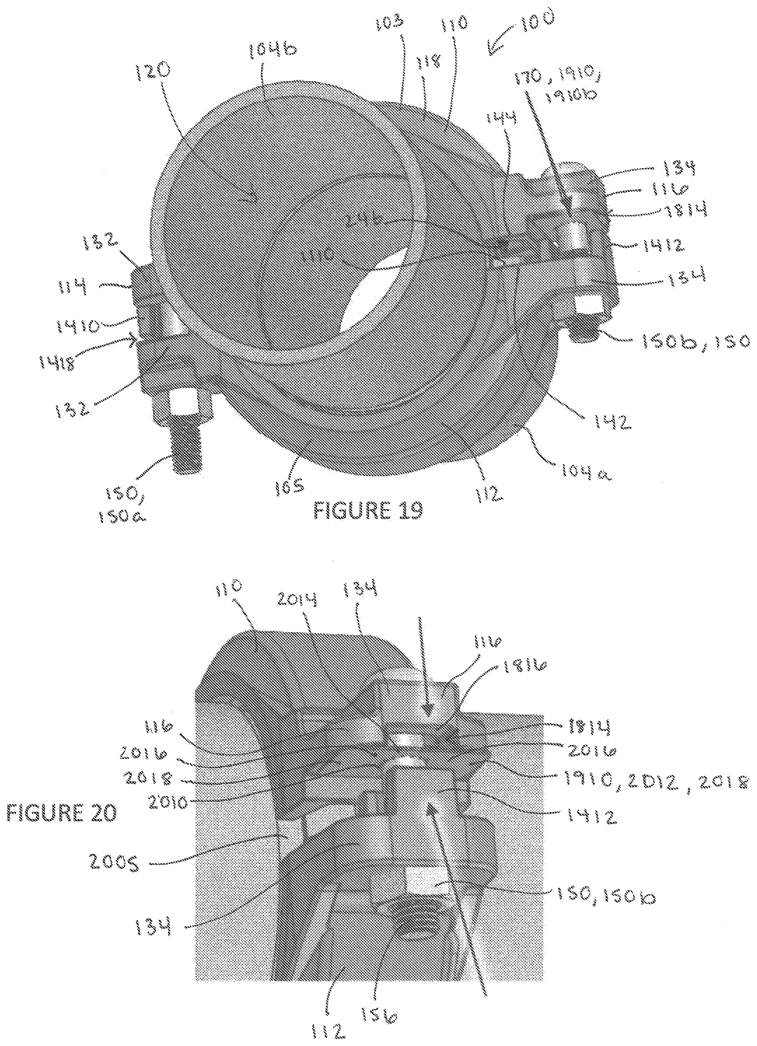

FIG. 1 illustrates a front view and FIG. 2 illustrates a cross-sectional view of a coupling assembly 100 according to an example aspect of the present disclosure. Additional example aspects of such a coupling assembly are disclosed in U.S. Pat. No. 9,194,516, issued on Nov. 24, 2015, which is hereby specifically incorporated by reference herein in its entirety. The coupling assembly 100 is illustrated in an untightened configuration. The coupling assembly 100 can comprise a pipe coupling 103 and at least one installation indicator 170. Example aspects of the pipe coupling 103 can be connected to one or more pipe sections 104 or other pipe fittings. In other aspects, the coupling assembly 100 can be any suitable fitting assembly, and the pipe coupling 103 can be any suitable pipe fitting. The pipe coupling 103 can be configured to connect a first pipe section 104a to a second pipe section 104b (shown in FIG. 19) or another pipe fitting. Example aspects of the pipe coupling 103 can comprise a coupling body 105. The coupling body 105 can comprise a first coupling segment, such as an upper coupling segment 110, and a second coupling segment, such as a lower coupling segment 112.

In example aspects, the upper and lower coupling segments 110,112 can comprise a cast material, such cast iron, including ductile iron in some aspects. In other example aspects, the upper and lower coupling segments 110,112 can be formed from another suitable material, or a combination of materials, that are known in the art, including but not limited to other metals, plastics, composites, and the like. Moreover, the upper and lower coupling segments 110,112 can be identical in the present aspect. However, when assembled to form the coupling assembly 100, the upper and lower coupling segments 110,112 are not mirror images across the horizontal, relative to the orientation shown. Rather, the lower coupling segment 112 can be flipped about the vertical with respect to the upper coupling segment 110, as shown. In other aspects, the upper and lower coupling segments 110,112 can be mirror images across the horizontal, or the upper and lower coupling segments 110, 112 may not be identical at all.

Each of the upper and lower coupling segments 110,112 can be substantially C-shaped in the present aspect. In other aspects, the coupling body 105 can comprise more or fewer coupling segments. In example aspects, each of the upper and lower coupling segments 110,112 can define a first end 114, an opposing second end 116, and a central section 118 extending between the first end 114 and second end 116. A coupling void 120 can be defined between the upper and lower coupling segments 110,112, and more specifically, between the central section 118 of the upper coupling segment 110 and the central section 118 of the lower coupling segment 112. A coupling axis 122 (going into the page in FIG. 1) can extend centrally through the coupling void 120. The coupling void 120 can be configured to receive opposing pipe ends 106 of the pipe sections 104 (such as the first pipe section 104a and the second pipe section 104b) to couple the first pipe section 104a to the second pipe section 104b.

Additionally, each of the upper and lower coupling segments 110,112 can define an axially front end 124 and an axially rear end 224 (shown in FIG. 2) opposite the axially front end 124. Each of the upper and lower coupling segments 110,112 can further define an outer surface 126 and an inner surface 128. The inner surface 128 of the upper coupling segment 110 can face the inner surface 128 of the lower coupling segment 112, and the inner surfaces 128 of the upper and lower coupling segments 110,112 can define the coupling void 120. A coupling gasket 160 can be arranged within the coupling void 120. In example aspects, the inner surfaces 128 of the upper and lower coupling segments 110,112 can define a gasket channel 228 (shown in FIG. 2) within which the coupling gasket 160 can be received. In an assembled and tightened configuration of the coupling assembly 100, the coupling gasket 160 can be compressed or stretched between the inner surfaces 128 of the upper and lower coupling segments 110,112 and an outer pipe surface 108 of the pipe sections 104 to allow the coupling assembly 100 to seal with the pipe sections 104.

In the present aspect, each of the coupling segments 110,112 can define an arcuate key 130 extending along the central section 118 at each of the axially front end 124 and the axially rear end 224. The gasket channel 228 can be defined axially between the opposing arcuate keys 130 formed at the axially front end 124 and the axially rear end 224 of the upper and lower coupling segments 110,112. In some aspects, the first pipe section 104a and/or the second pipe section 104b can define grooved or shouldered ends 2005 (shown in FIG. 20), and the arcuate keys 130 at the corresponding axially front end 124 and axially rear end 224 of the coupling segments 110,112 can engage the grooved or shouldered ends 2005 when the coupling segments 110,112 are drawn together by tightening one or more coupling fasteners 150. The coupling fasteners 150 are described in further detail below.

In some aspects, the arcuate keys 130 can further define gripping features, such as teeth, to grip the pipe sections 104. In other aspects, the first pipe section 104a and/or second pipe section 104b can define plain ends, and the first and second arcuate keys 130 can grip the outer pipe surface 108 of the plain ends of the pipe sections 104. Plain ends can be ends that do not define a designated groove or shoulder to be engaged by the arcuate keys 130. In some aspects, either or both of the upper and lower coupling segments 110,112 can be configured to deform around the pipe sections 104 to ensure that the coupling segments 110,112 have properly engaged the pipe sections 104 and to ensure that the coupling gasket 160 is properly sealed against the outer pipe surface 108 of each of the pipe sections 104.

A first fastener pad 132 can be formed at the first end 114 of each of the upper and lower coupling segments 110,112, and a second fastener pad 134 can be formed at the second end 116 of each of the upper and lower coupling segments 110,112. The central section 118 of each of the upper and lower coupling segments 110,112 can define a substantially arcuate shape and can extend between the corresponding first and second fastener pads 132,134. The first fastener pad 132 of the upper coupling segment 110 can be substantially vertically aligned with the first fastener pad 132 of the lower coupling segment 112, relative to the orientation shown. The second fastener pad 134 of the upper coupling segment 110 can be substantially vertically aligned with the second fastener pad 134 of the lower coupling segment 112, relative to the orientation shown. Each of the first fastener pads 132 can define a first fastener opening 232 (shown in FIG. 2) formed therethrough, and a first fastener gap 136 can be defined between the aligned pair of first fastener openings 232. Similarly, each of the second fastener pads 134 can define a second fastener opening 234 (shown in FIG. 2) formed therethrough, and a second fastener gap 138 can be defined between the aligned pair of second fastener openings 234.

In example aspects, a first coupling tab 140 and a second coupling tab 240 (shown in FIG. 2) can extend from the inner surface 128 of the upper coupling segment 110 proximate to the first end 114 thereof. Specifically, the first and second coupling tabs 140,240 can extend downwards from a primary pad shoulder 142 of the upper coupling segment 110 towards the lower coupling segment 112, relative to the orientation shown, and can be positioned between the corresponding first fastener opening 232 and the central section 118/coupling void 120. The first coupling tab 140 can be arranged proximate to the axially front end 124 of the upper coupling segment 110, and the second coupling tab 240 can be arranged proximate to the axially rear end 224 of the upper coupling segment 110. Each of the first and second coupling tabs 140,240 of the upper coupling segment 110 can engage a corresponding coupling groove 246 (shown in FIG. 2) formed in a secondary pad shoulder 144 of the lower coupling segment 112 when the coupling fasteners 150 are tightened. The coupling groove 246 can be formed in the inner surface 128 of the lower coupling segment 112 proximate to the first end 114 thereof, and in some aspects, the coupling groove 246 can be in communication with the coupling void 120, as shown in FIG. 2. The engagement of the first and second coupling tabs 140,240 with the coupling groove 246 can properly align the upper coupling segment 110 with the lower coupling segment 112, and in some aspects, can prevent the coupling gasket 160 from extruding out of the gasket channel 228 between the upper and lower coupling segments 110,112.

Similarly, the lower coupling segment 112 can comprise one of the first coupling tabs 140 and one of the second coupling tabs 240 extending from the inner surface 128 thereof, proximate to the second end 116 of the lower coupling segment 112. Specifically, the first and second coupling tabs 140,240 of the lower coupling segment 112 can extend upwards from the corresponding primary pad shoulder 142 towards the upper coupling segment 110, relative to the orientation shown, and can be positioned between the corresponding second fastener opening 234 and the central section 118/coupling void 120. The first coupling tab 140 can be arranged proximate to the axially front end 124 of the lower coupling segment 112, and the second coupling tab 240 can be arranged proximate to the axially rear end 224 of the lower coupling segment 112. Each of the first and second coupling tabs 140,240 of the lower coupling segment 112 can engage a corresponding one of the coupling grooves 246 formed in the secondary pad shoulder 144 of the upper coupling segment 110 when the coupling fasteners 150 are tightened, as previously described. The coupling groove 246 can be formed in the inner surface 128 of the upper coupling segment 110 proximate to the second end 116 thereof.

According to example aspects, the upper and lower coupling segments 110,112 can be secured together and tightened around the pipe sections 104 by the one or more of the coupling fasteners 150. In the present aspect, the coupling fasteners 150 can comprise a first fastener 150a and a second fastener 150b. As shown, the first fastener 150a can extend through the each of the first fastener openings 232 to couple the upper and lower coupling segments 110,112 together at the first ends 114 thereof, and the second fastener 150b can extend through each of the second fastener openings 234 to couple the upper and lower coupling segments 110,112 together at the second ends 116 thereof. Each of the first and second fasteners 150a,b can be selectively loosened and tightened, as described in further detail below. In the present aspect, each of the first and second fasteners 150a,b can comprise a threaded bolt 152 and a threaded nut 158. The threaded bolt 152 can define a bolt head 154 and a bolt shaft 156. The bolt shaft 156 can define shaft threading 157 distal to the bolt head 154, as shown, which can threadedly engaged the threaded nut 158.

In example aspects, the bolt head 154 of each coupling fastener 150 can face the outer surface 126 of the upper coupling segment 110, and the bolt head 154 can be sized to prohibit passage through the corresponding first fastener opening 232 or second fastener opening 234 of the upper coupling segment 110. The bolt shaft 156 of the first fastener 150a can extend through each of the first fastener openings 232 and can span the corresponding first fastener gap 136 defined between the first fastener pads 132. The bolt shaft 156 of the second fastener 150b can extend through each of the second fastener openings 234 and can span the corresponding second fastener gap 138 defined between the second fastener pads 134. The threaded nut 158 of each coupling fastener 150 can be threaded onto the corresponding bolt shaft 156, distal to the bolt head 154, and can face the outer surface 126 of the lower coupling segment 112. The threaded nut 158 can be sized to prohibit passage through the corresponding first fastener opening 232 or second fastener opening 234 of the lower coupling segment 112. To configure the pipe coupling 103 in the tightened configuration, the threaded nut 158 of each coupling fastener 150 can be tightened on corresponding the bolt shaft 156 to draw the first ends 114 of the upper and lower coupling segments 110,112 closer together and the second ends 116 of the upper and lower coupling segments 110,112 closer together. In other aspects, the coupling fasteners 150 can be any other suitable fastener known in the art, including screws, set screws, rivets, and the like.

In some aspects, after the first and second pipe sections 104a,b are inserted into the coupling gasket 160, the coupling segments 110,112 can be assembled around a joint between the first pipe section 104a and the second pipe section 104b. In other aspects, the coupling segments 110,112 can be placed onto the pipe end 106 of the first pipe section 104a in a pre-assembled configuration, wherein the coupling fasteners 150 can be loosened to connect the coupling segments 110,112 together in the untightened configuration. The coupling segments 110,112 can then receive the corresponding pipe end 106 of the second pipe section 104b and the coupling fasteners 150 can be tightened to join the first pipe section 104a to the second pipe section 104b. In other aspects, pre-assembled coupling segments 110,112 can be placed onto and slid over the first pipe section 104a, the second pipe section 104b can then be aligned with the first pipe section 104a, and the coupling segments 110,112 can be slid back to cover the joint, before tightening the coupling fasteners 150 to clamp the coupling segments 110,112 around the first and second pipe sections 104a,b.

The coupling assembly 100 can further comprise one or more of the installation indicators 170 that can indicate when the coupling assembly 100 is suitably tightened in the tightened configuration. For example, in the present aspect, the installation indicators 170 can comprise a first indicator 170a and a second indicator 170b. In the present aspect, the installation indicators 170 can be formed monolithically with the coupling gasket 160 (i.e., formed a singular component that constitutes a single material without joints or seams). In other aspects, the installation indicators 170 can be formed separately from the coupling gasket 160, as described in further detail below. Example aspects of the coupling gasket 160, including the monolithically formed installation indicators 170, can comprise a substantially resilient, flexible material. For example, in some aspects, the coupling gasket 160 can comprise a rubber material such as EPDM rubber. In other aspects, the coupling gasket 160 can comprise any suitable flexible and resilient material known in the art, including but not limited to, various types of rubbers, foams, plastics, and the like. Other aspects of the installation indicators 170 can comprise a less resilient material, such as a metal material, for example and without limitation.

As shown, the coupling gasket 160 can comprise a substantially annular gasket body 162, and each of the installation indicators 170 can extend radially outward from the gasket body 162, relative to the coupling axis 122. The first indicator 170a can be disposed substantially opposite the second indicator 170b. The gasket body 162 can be received within the coupling void 120, while the first and second indicators 170a, 170b can extend outward beyond the coupling void 120 to be positioned between the first ends 114 and second ends 116, respectively, of the upper and lower coupling segments 110,112. More specifically, the first indicator 170a can be arranged between the primary pad shoulder 142 of the upper coupling segment 110 and the secondary pad shoulder 144 of the lower coupling segment 112, and the second indicator 170b can be positioned between the secondary pad shoulder 144 of the upper coupling segment 110 and the primary pad shoulder 142 of lower coupling segment 112, as shown. Each of the first and second indicators 170a,b can extend in between the corresponding first and second coupling tabs 140,240 and can extend radially outward beyond the corresponding first and second coupling tabs 140,240 and the corresponding coupling groove 246.

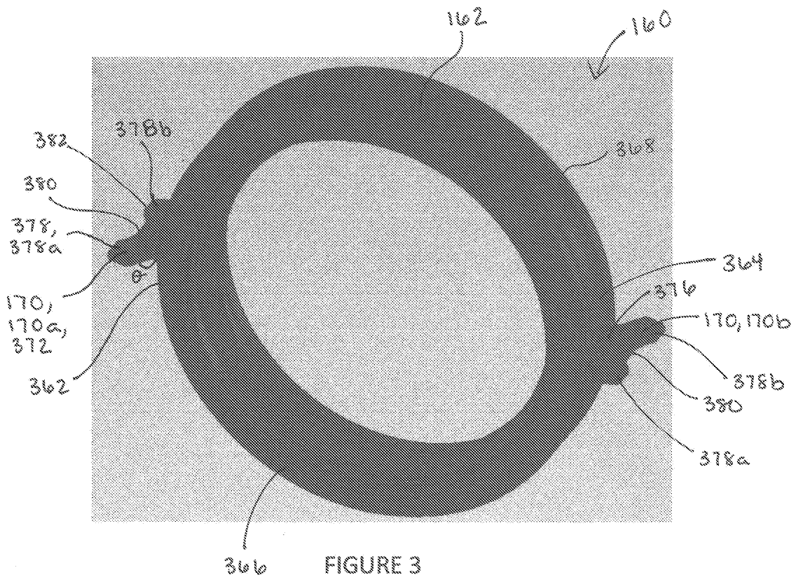

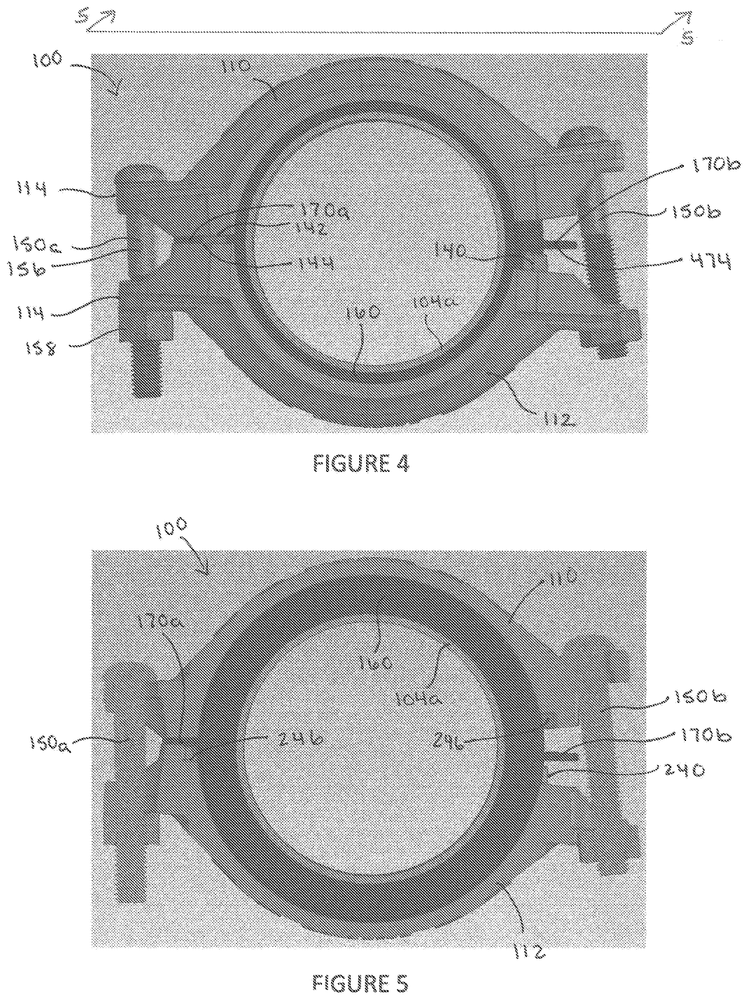

FIG. 3 illustrates an example aspect of the coupling gasket 160. As shown, the coupling gasket 160 can comprise the substantially annular gasket body 162. The first indicator 170a can extend radially outward from the gasket body 162 at a first gasket side 362, and the second indicator 170b can extend radially outward from the gasket body 162 at a second gasket side 364, opposite the first gasket side 362. In example aspects, a top indicator side 372 of each installation indicator 170 can be substantially planar, and a bottom indicator side 474 (shown in FIG. 4) of each installation indicator 170 can be substantially planar. In other aspects, the top indicator side 372 and/or the bottom indicator side 474 may not be substantially planar.

In some example aspects, each of the installation indicators 170 can be substantially T-shaped, Y-shaped, or V-shaped. In the present aspect, the installation indicators 170 can be substantially Y-shaped. For example, each of the installation indicators 170 can define a stem 376 extending radially outward from the gasket body 162, and pair of flukes 378 extending from the stem 376 opposite the gasket body 162. As such, the installation indicators 170 of the present aspect can be said to generally define the shape of a “whale tail”. Other aspects of the installation indicator 170 may not comprise the stem 376 and can comprise the pair of flukes 378 only (e.g., can be substantially V-shaped). The pair of flukes 378 can comprise a first fluke 378a extending towards an axially front gasket end 366 of the coupling gasket 160 at an angle θ relative to the stem 376 and a second fluke 378b extending towards an axially rear gasket end 368 of the coupling gasket 160 at the angle θ relative to the stem 376. The angle θ can be obtuse in the present aspect to define the Y-shape of the installation indicator 170. In other aspects, the angle θ can be any other suitable angle. A fluke notch 380 can be defined between the first fluke 378a and the second fluke 378b at a distal indicator end 382 of the installation indicator 170, opposite the stem 376. The fluke notch 380 can be substantially arcuate in some aspects, and can be configured to provide suitable clearance between the installation indicator 170 and the adjacent coupling fastener 150 (shown in FIG. 1).

FIG. 4 illustrates a front view and FIG. 5 illustrates a cross-sectional view of the coupling assembly 100 in a partially tightened configuration, wherein the first fastener 150a can be tightened and the second fastener 150b can remain untightened. As shown, the first fastener 150a can be tightened by threading the threaded nut 158 along the bolt shaft 156 to draw the first end 114 of the lower coupling segment 112 towards the first end 114 of the upper coupling segment 110. The first fastener 150a can be tightened until the first indicator 170a is clamped between the upper and lower coupling segments 110,112, and more specifically, between the primary pad shoulder 142 of the upper coupling segment 110 and the secondary pad shoulder 144 of the lower coupling segment 112. Moreover, in example aspects, the first and second coupling tabs 140,240 (second coupling tab 240 shown in FIG. 5) of the upper coupling segment 110 can engage the coupling groove 246 (shown in FIG. 5) of the lower coupling segment 112 when the first fastener 150a is tightened.

According to example aspects, the resistance felt manually by the installer when the first fastener 150a has been appropriately tightened to clamp the first indicator 170a between the upper and lower coupling segments 110,112 can indicate to the installer that the first fastener 150a is tightened to a suitable torque. Additionally, the installer would be able to visually observe that the first indicator 170a is clamped between the upper and lower coupling segments 110,112. In some aspects, the first indicator 170a may extrude out from between the corresponding primary pad shoulder 142 and secondary pad shoulder 144 to further visually indicate that the first fastener 150a has been suitably tightened. Moreover, in example aspects, the arrangement of the first indicator 170a between the primary pad shoulder 142 and the secondary pad shoulder 144 can maintain a desired pad spacing between the primary pad shoulder 142 and the secondary pad shoulder 144 when the first fastener 150a is tightened. The second fastener 150b can then be tightened in the same manner to configure the coupling assembly 100 in the fully tightened configuration.

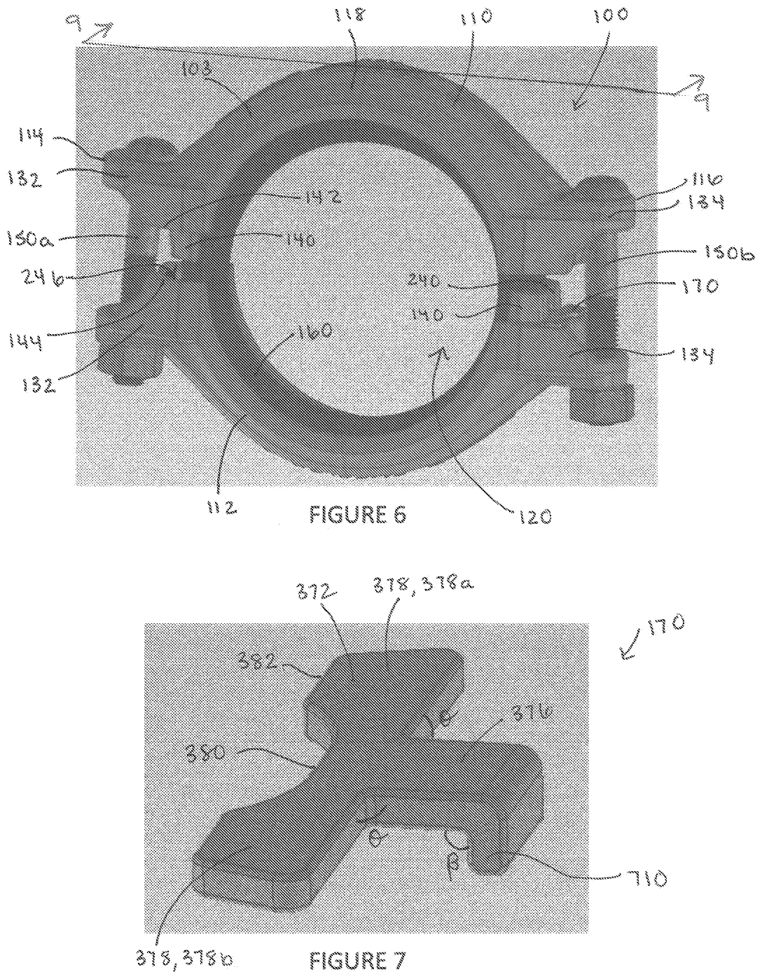

FIG. 6 illustrates a perspective view of the coupling assembly 100 according to another example aspect of the disclosure. The coupling assembly 100 is illustrated in the untightened configuration. Similar to the previously described coupling assembly 100, the coupling assembly 100 of the present aspect can comprise the pipe coupling 103 and at least one installation indicator 170. The pipe coupling 103 can comprise the upper coupling segment 110, the lower coupling segment 112, and the coupling gasket 160 disposed within the coupling void 120. Each of the upper and lower coupling segments 110,112 can comprise the first fastener pad 132, the second fastener pad 134, and the substantially arcuate central section 118 therebetween. The opposing central sections 118 can define the coupling void 120 therebetween.

The first fastener 150a can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the first and second coupling tabs 140,240 extending therefrom, and the second fastener pad 134 of the upper coupling segment 110 can define the secondary pad shoulder 144 and the coupling groove 246 extending into the secondary pad shoulder 144. Conversely, the first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the first and second coupling tabs 140,240 extending therefrom.

In the present aspect, the at least one installation indicator 170 can be formed separately from the coupling gasket 160. Only one installation indicator 170 is shown in the present view, arranged between second fastener pads 134 of the upper and lower coupling segments 110,112. More specifically, the installation indicator 170 can be arranged between the secondary pad shoulder 144 of the upper coupling segment 110 and the primary pad shoulder 142 of the lower coupling segment 112. As previously described, the installation indicator 170 can extend between the first and second coupling tabs 140,240 of the lower coupling segment 112 and can extend radially outward beyond the first and second coupling tabs 140,240 and the corresponding coupling groove 246. In other aspects, an additional one of the installation indicators 170 can be arranged between the first fastener pads 132 of the upper and lower coupling segments 110,112.

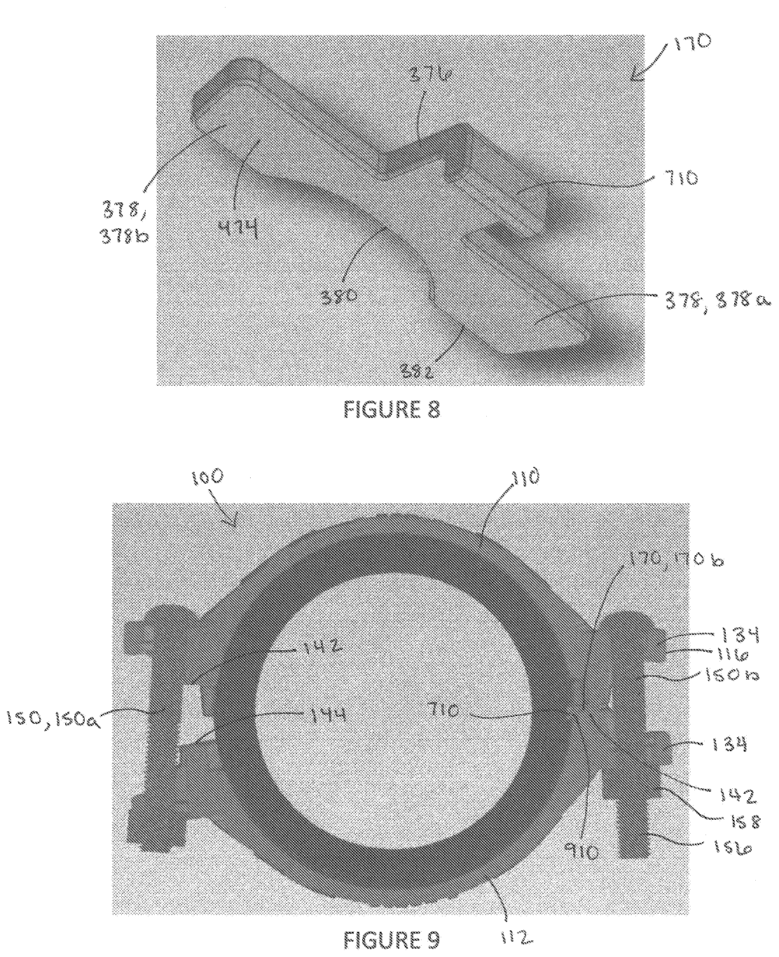

FIGS. 7 and 8 illustrate top and bottom perspective views of the installation indicator 170, respectively. Example aspects of the installation indicator 170 can again comprise a substantially resilient, flexible material, such as EPDM rubber, for example and without limitations. In other aspects, installation indicator 170 can comprise any other suitable flexible and resilient material known in the art, including but not limited to, various types of rubbers, foams, plastics, and the like, or alternatively may comprise a less resilient material, such as metal for example and without limitation. According to example aspects, the installation indicator 170 can be similarly shaped to the previously described installation indicators 170. For example, as shown, the installation indicator 170 of the present aspect can comprise the stem 376 and the pair of flukes 378 to generally define the “whale tail” shape. In the present aspect, each of the first fluke 378a and the second fluke 378b can be oriented substantially perpendicular to the stem 376, such that the angle θ can be about 90°. In other aspects, however, the angle θ can be greater or lesser than 90°. The fluke notch 380 can be defined between the first fluke 378a and the second fluke 378b at the distal indicator end 382 to accommodate the corresponding coupling fastener 150 (shown in FIG. 6).

The pair of flukes 378 can be substantially coplanar with the stem 376, such that the top indicator side 372 and the bottom indicator side 474 (shown in FIG. 8) can again each be substantially planar. However, in the present aspect, the installation indicator 170 can further comprise a catch tab 710 extending substantially downward from the stem 376 at an angle β, opposite the pair of flukes 378, relative to the orientation shown in FIGS. 7 and 8. The angle β can be about 90° in the present aspect; however, in other aspects, the angle β can define any other suitable angle. The catch tab 710 can be configured to hook onto either the upper coupling segment 110 or the lower coupling segment 112 (both shown in FIG. 9) to retain the installation indicator 170 in position.

FIG. 9 illustrates a cross-sectional view of the coupling assembly 100 in the partially tightened configuration, wherein the second fastener 150b can be tightened and the first fastener 150a can remain untightened. As shown, the catch tab 710 of the installation indicator 170 can hook onto an inner edge 910 of the primary pad shoulder 142 of the lower coupling segment 112 to retain the installation indicator 170 between the second fastener pads 134 of the upper and lower coupling segments 110,112. As shown, the second fastener 150b can be tightened by threading the threaded nut 158 along the bolt shaft 156 to draw the second end 116 of the lower coupling segment 112 towards the second end 116 of the upper coupling segment 110. As previously described, the second fastener 150b can be tightened until the installation indicator 170 is clamped between the upper and lower coupling segments 110,112, and more specifically, between the secondary pad shoulder 144 of the upper coupling segment 110 and the primary pad shoulder 142 of the lower coupling segment 112.

Resistance can be manually felt by the installer and can indicate when the second fastener 150b has been tightened to a suitable torque. The installer can also visually observe that the installation indicator 170 is clamped between the upper and lower coupling segments 110,112. In some aspects, the installation indicator 170 may extrude out from between the second fastener pads 134 to further visually indicate the second fastener 150b is suitably tightened. The arrangement of the installation indicator 170 between the primary pad shoulder 142 of the lower coupling segment 112 and the secondary pad shoulder 144 of the upper coupling segment 110 can maintain a desired pad spacing between the primary pad shoulder 142 and the secondary pad shoulder 144 when the second fastener 150b is tightened. As shown in FIG. 10, the first fastener 150a can then be tightened in the same manner to configure the coupling assembly 100 in the fully tightened configuration.

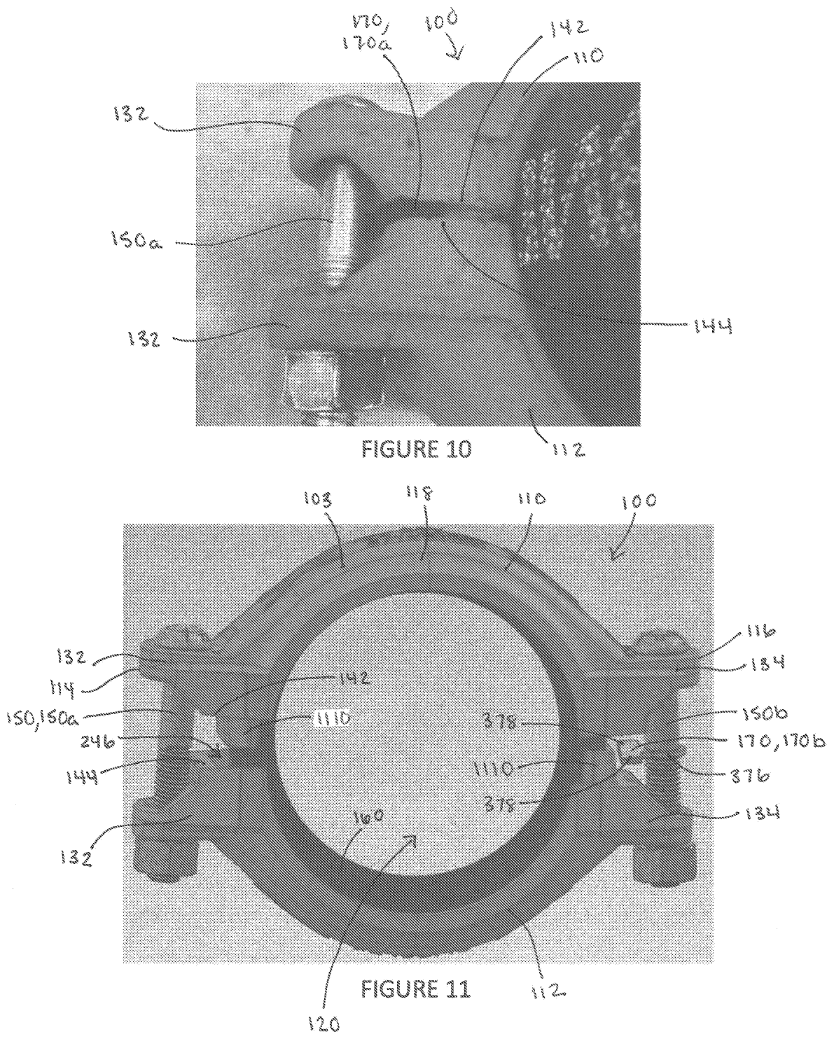

FIG. 11 illustrates a perspective view of the coupling assembly 100 according to another example aspect of the disclosure. The coupling assembly 100 is illustrated in the untightened configuration. Similar to the previously described coupling assemblies 100, the coupling assembly 100 of the present aspect can comprise the pipe coupling 103 and at least one installation indicator 170. The pipe coupling 103 can comprise the upper coupling segment 110, the lower coupling segment 112, and the coupling gasket 160 disposed within the coupling void 120. Each of the upper and lower coupling segments 110,112 can comprise the first fastener pad 132, the second fastener pad 134, and the substantially arcuate central section 118 therebetween. The opposing central sections 118 can define the coupling void 120 therebetween.

The first fastener 150a can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142, and the second fastener pad 134 of the upper coupling segment 110 can define the secondary pad shoulder 144 and the coupling groove 246 extending into the secondary pad shoulder 144. The first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142. In the present aspect, instead of the first and second coupling tabs 140,240 (shown in FIGS. 1 and 2) extending from each primary pad shoulder 142, a singular coupling tongue 1110 can extend from the primary pad shoulder 142, which can engage the corresponding coupling groove 246 in the tightened configuration.

In the present aspect, the at least one installation indicator 170 can be formed separately from the coupling gasket 160 and can be mounted to the corresponding coupling fastener 150. Only one installation indicator 170 is shown in the present view, which can be mounted to the second fastener 150b and arranged between second fastener pads 134 of the upper and lower coupling segments 110,112. More specifically, the stem 376 of the installation indicator 170 can be mounted to the second fastener 150b, and the pair of flukes 378 of the installation indicator 170 can be arranged between the secondary pad shoulder 144 of the upper coupling segment 110 and the primary pad shoulder 142 of the lower coupling segment 112. In other aspects, an additional one of the installation indicators 170 can be mounted to the first fastener 150a and arranged between the first fastener pads 132 of the upper and lower coupling segments 110,112.

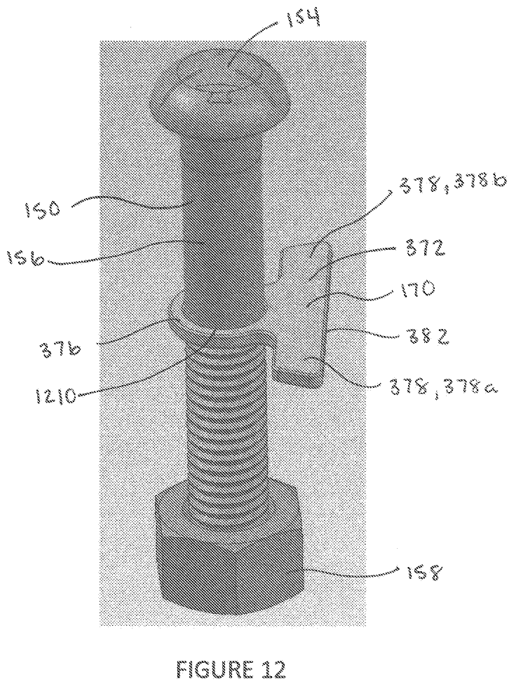

FIG. 12 illustrates the installation indicator 170 mounted to the coupling fastener 150. Example aspects of the installation indicator 170 can again comprise a substantially resilient, flexible material, such as EPDM rubber, for example and without limitations. In other aspects, installation indicator 170 can comprise any other suitable flexible and resilient material known in the art, including but not limited to, various types of rubbers, foams, plastics, and the like, or alternatively can comprise a less resilient material, such as metal for example and without limitations. The installation indicator 170 can comprise the stem 376 and the pair of flukes 378 to generally define the “whale tail” shape.

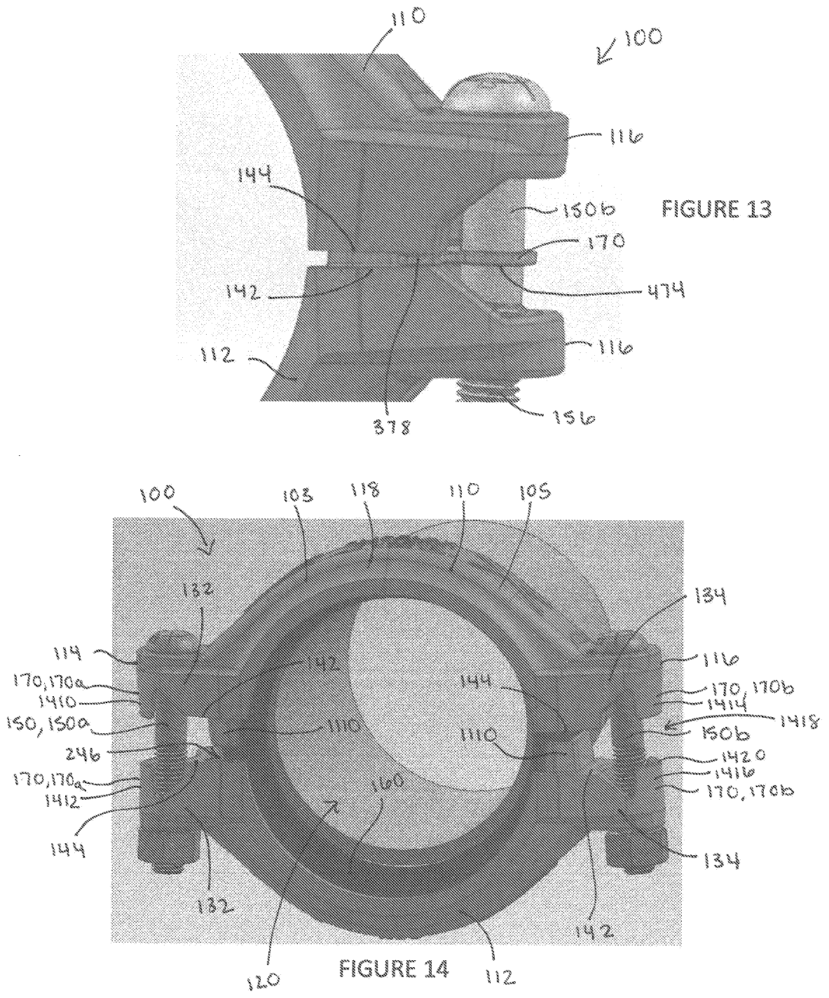

In the present aspect, each of the first fluke 378a and the second fluke 378b can be substantially coplanar with and oriented substantially perpendicular to the stem 376. The top indicator side 372 and the bottom indicator side 474 (shown in FIG. 13) can each be substantially planar. In the present aspect, the stem 376 can be substantially annular in shape and can define a bolt opening 1210 therethrough for receiving the bolt shaft 156 of the coupling fastener 150. The installation indicator 170 does not comprise the fluke notch 380 (shown in FIG. 3) between the first fluke 378a and the second fluke 378b at the distal indicator end 382, such that the pair of flukes 378 could be said to together define one continuous fluke 378 in the present aspect. The installation indicator 170 can be substantially T-shaped in the present aspect. When the coupling assembly 100 (shown in FIG. 11) is assembled, the pair of flukes 378 can extend radially inward from the stem 376 towards the coupling void 120 (shown in FIG. 11).

FIG. 13 illustrates the second fastener 150b tightened to clamp the installation indicator 170 between the second ends 116 of the upper and lower coupling segments 110,112. The second fastener 150b can be tightened, with the installation indicator 170 mounted thereto, by threading the threaded nut 158 (shown in FIG. 12) along the bolt shaft 156 to draw the second end 116 of the lower coupling segment 112 towards the second end 116 of the upper coupling segment 110. The second fastener 150b can be tightened until the installation indicator 170 is clamped between the upper and lower coupling segments 110,112, and more specifically, until the pair of flukes 378 are clamped between the secondary pad shoulder 144 of the upper coupling segment 110 and the primary pad shoulder 142 of the lower coupling segment 112. In the ways previously described (e.g., visually and/or by manual resistance), the installation indicator 170 can indicate to an installer that the second fastener 150b is suitably tightened. The installation indicator 170 can also maintain a desired pad spacing between the primary pad shoulder 142 and the secondary pad shoulder 144 when the second fastener 150b is tightened. The first fastener 150a (shown in FIG. 11) can be tightened in the same manner to configure the coupling assembly 100 in the fully tightened configuration.

FIG. 14 illustrates a perspective view of the coupling assembly 100 according to another example aspect of the disclosure. The coupling assembly 100 is illustrated in the untightened configuration. Similar to the previously described coupling assemblies 100, the coupling assembly 100 of the present aspect can comprise the pipe coupling 103 and at least one installation indicator 170. The pipe coupling 103 can comprise the upper coupling segment 110, the lower coupling segment 112, and the coupling gasket 160 disposed within the coupling void 120. Each of the upper and lower coupling segments 110,112 can comprise the first fastener pad 132, the second fastener pad 134, and the substantially arcuate central section 118 therebetween. The opposing central sections 118 can define the coupling void 120 therebetween.

The first fastener 150a can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the coupling tongue 1110 extending therefrom, and the second fastener pad 134 of the upper coupling segment 110 can define the secondary pad shoulder 144 and the coupling groove 246 extending into the secondary pad shoulder 144. Conversely, the first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the coupling tongue 1110 extending therefrom.

In the present aspect, the at least one installation indicator 170 can comprise the first indicator 170a and the second indicator 170b. Each of the first indicator 170a and the second indicator 170b can be formed monolithically with the coupling body 105. More specifically, the first indicator 170a can be formed monolithically with the first fastener pads 132 of the upper and lower coupling segments 110,112, and the second indicator 170b can be formed monolithically with the second fastener pads 134 of the upper and lower coupling segments 110,112. The first indicator 170a can comprise a first upper tooth 1410 formed monolithically with the first fastener pad 132 of the upper coupling segment 110 at the first end 114 thereof and a first lower tooth 1412 formed monolithically with the first fastener pad 132 of the lower coupling segment 112 at the first end 114 thereof. Similarly, the second indicator 170b can comprise a second upper tooth 1414 formed monolithically with the second fastener pad 134 of the upper coupling segment 110 at the second end 116 thereof and a second lower tooth 1416 formed monolithically with the second fastener pad 134 of the lower coupling segment 112 at the second end 116 thereof.

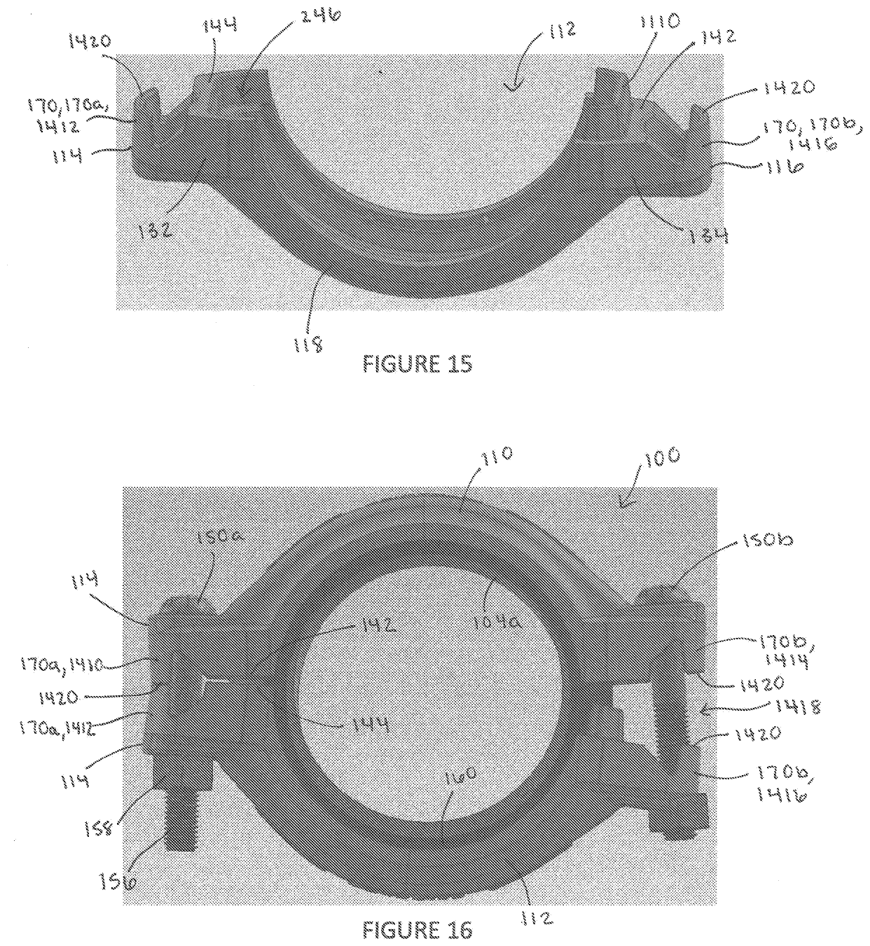

According to example aspects, each of the first upper tooth 1410, the first lower tooth 1412, the second upper tooth 1414, and the second lower tooth 1416 can define a distal tooth edge 1420. The first upper tooth 1410 can extend downward beyond the adjacent primary pad shoulder 142 of the upper coupling segment 110, and the second upper tooth 1414 can extend downward beyond the adjacent secondary pad shoulder 144 of the upper coupling segment 110, relative to the orientation shown. Similarly, the first lower tooth 1412 can extend upward beyond the adjacent secondary pad shoulder 144 of the lower coupling segment 112, and the second lower tooth 1416 can extend upward beyond the adjacent primary pad shoulder 142 of the lower coupling segment 112, relative to the orientation shown. In the untightened configuration, a tooth gap 1418 can be defined between the first upper tooth 1410 and the first lower tooth 1412 and between the second upper tooth 1414 and the second lower tooth 1416. In the tightened configuration, the distal tooth edge 1420 of the first upper tooth 1410 can be pressed against the distal tooth edge 1420 of the first lower tooth 1412, and the distal tooth edge 1420 of the second upper tooth 1414 can be pressed against the distal tooth edge 1420 of the second lower tooth 1416. FIG. 15 illustrates the lower coupling segment 112, which can be identical to the upper coupling segment 110.

FIG. 16 illustrates a front view of the coupling assembly 100 in the partially tightened configuration, wherein the first fastener 150a can be tightened and the second fastener 150b can remain untightened. As shown, the first fastener 150a can be tightened by threading the threaded nut 158 along the bolt shaft 156 to draw the first end 114 of the lower coupling segment 112 towards the first end 114 of the upper coupling segment 110. The first fastener 150a can be tightened until the distal tooth edge 1420 of the first upper tooth 1410 of the first indicator 170a is pressed against the distal tooth edge 1420 of the first lower tooth 1412 of the first indicator 170a. Manual resistance felt by the installer when the first upper tooth 1410 is pressed against the first lower tooth 1412 can indicate to the installer that the first fastener 150a has been tightened to a suitable torque. The installer can also visually observe that the first upper tooth 1410 is pressed against the first lower tooth 1412, eliminating the tooth gap 1418 therebetween. Moreover, because the first upper tooth 1410 can extend downward beyond the adjacent primary pad shoulder 142 of the upper coupling segment 110 and the first lower tooth 1412 can extend upward beyond the adjacent secondary pad shoulder 144 of the lower coupling segment 112, the desired pad spacing can be maintained between the primary pad shoulder 142 and the secondary pad shoulder 144 when the first fastener 150a is tightened. The second fastener 150b can then be tightened in the same manner to configure the coupling assembly 100 in the fully tightened configuration. FIG. 17 illustrates a detail view of the first fastener 150a fully tightened to press the distal tooth edge 1420 of the first upper tooth 1410 against the distal tooth edge 1420 of the first lower tooth 1412.

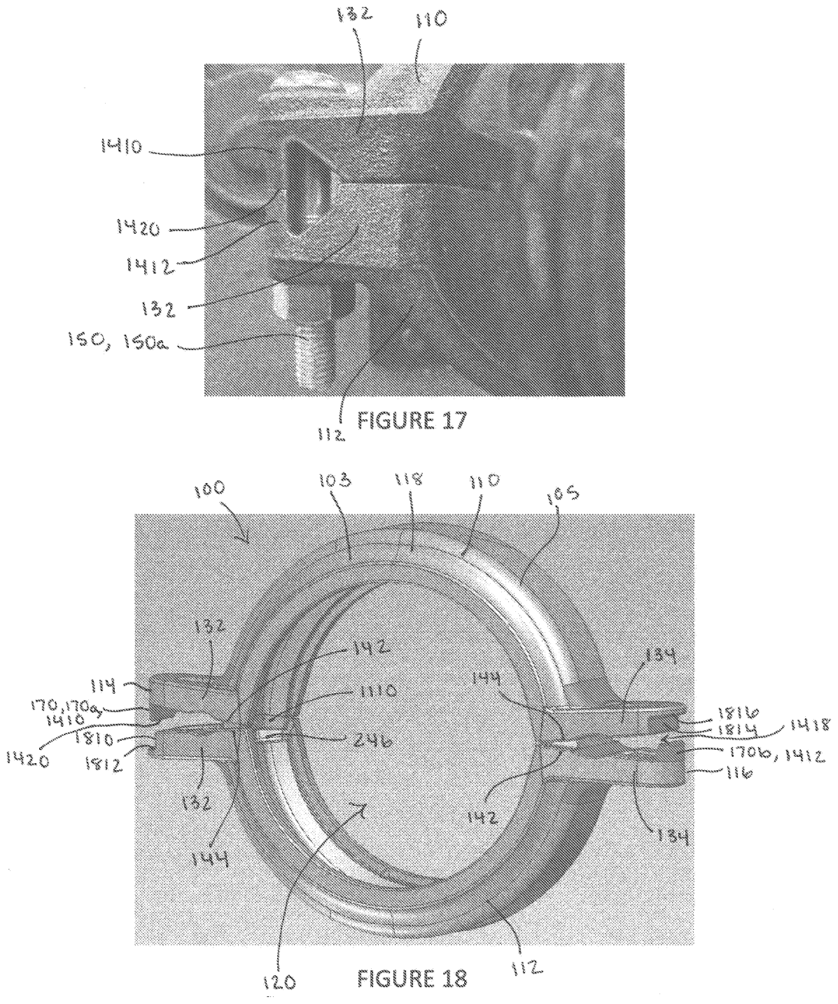

FIG. 18 illustrates a perspective view of the coupling assembly 100 according to another example aspect of the disclosure. The coupling assembly 100 is illustrated in the untightened configuration. Similar to the previously described coupling assemblies 100, the coupling assembly 100 of the present aspect can comprise the pipe coupling 103 and at least one installation indicator 170. The pipe coupling 103 can comprise the upper coupling segment 110 and the lower coupling segment 112. In some example aspects, the coupling gasket 160 (shown in FIG. 1) can be disposed within the coupling void 120. Each of the upper and lower coupling segments 110,112 can comprise the first fastener pad 132, the second fastener pad 134, and the substantially arcuate central section 118 extending therebetween. The opposing central sections 118 can define the coupling void 120 therebetween.

The first fastener 150a (shown in FIG. 1) can couple the first fastener pad 132 of the upper coupling segment 110 to the first fastener pad 132 of the lower coupling segment 112 at the first ends 114 thereof. The second fastener 150b (shown in FIG. 1) can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the coupling tongue 1110 extending therefrom, and the second fastener pad 134 of the upper coupling segment 110 can define the secondary pad shoulder 144 and the coupling groove 246 extending into the secondary pad shoulder 144. Conversely, the first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the coupling tongue 1110 extending therefrom.

In the present aspect, the at least one installation indicator 170 can comprise the first indicator 170a and the second indicator 170b, each of which can be formed monolithically with the coupling body 105. More specifically, the first indicator 170a can be formed monolithically with the first fastener pad 132 of the upper coupling segment 110, and the second indicator 170b can be formed monolithically with the second fastener pad 134 of the lower coupling segment 112. The first indicator 170a can comprise the first upper tooth 1410 formed monolithically with the first fastener pad 132 of the upper coupling segment 110 at the first end 114 thereof. The second indicator 170b can comprise the first lower tooth 1412 formed monolithically with the second fastener pad 134 of the lower coupling segment 112 at the second end 116 thereof.

The first fastener pad 132 of the lower coupling segment 112 can define a lower notch 1810 and a lower shoulder 1812 formed monolithically therewith at the first end 114 thereof. In the tightened configuration, the first upper tooth 1410 can engage the lower notch 1810 and, in some aspects, the distal tooth edge 1420 of the first upper tooth 1410 can be pressed against the lower shoulder 1812. Similarly, the second fastener pad 134 of the upper coupling segment 110 can define an upper notch 1814 and an upper shoulder 1816 formed monolithically therewith at the second end 116 thereof. In the tightened configuration, the first lower tooth 1412 can engage the upper notch 1814 and, in some aspects, the distal tooth edge 1420 of the first lower tooth 1412 can be pressed against the upper shoulder 1816. In some example aspects, in the untightened configuration, the tooth gap 1418 can be defined between the first upper tooth 1410 and the lower shoulder 1812 and between the first lower tooth 1412 and the upper shoulder 1816.

Manual resistance felt by the installer when the first upper tooth 1410 is pressed against the lower shoulder 1812 and when the first lower tooth 1412 is pressed against the lower shoulder 1812 can indicate to the installer that the first fastener 150a and the second fastener 150b, respectively, have been tightened to a suitable torque. The installer can also visually observe that the first upper tooth 1410 is pressed against the lower shoulder 1812, eliminating the tooth gap 1418 therebetween, and that the first lower tooth 1412 is pressed against the upper shoulder 1816, eliminating the tooth gap 1418 therebetween. Moreover, the first indicator 170a and the second indicator 170b can be configured to allow the desired pad spacing to be maintained between the first fastener pads 132 and between the second fastener pads 134 in the tightened configuration.

FIGS. 19 and 20 illustrate a front perspective view and an end perspective view, respectively, of the coupling assembly 100 according to another example aspect of the disclosure. The coupling assembly 100 is illustrated in the untightened configuration. Similar to the previously described coupling assemblies 100, the coupling assembly 100 of the present aspect can comprise the pipe coupling 103 and at least one installation indicator 170. The pipe coupling 103 can comprise the upper coupling segment 110, the lower coupling segment 112, and the coupling gasket 160 (shown in FIG. 1) disposed within the coupling void 120. Each of the upper and lower coupling segments 110,112 can comprise the first fastener pad 132, the second fastener pad 134, and the substantially arcuate central section 118 extending therebetween. The opposing central sections 118 can define the coupling void 120 therebetween.

The first fastener 150a can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the coupling tongue 1110 extending therefrom, and the second fastener pad 134 of the upper coupling segment 110 can define the secondary pad shoulder 144 and the coupling groove 246 extending into the secondary pad shoulder 144. Conversely, the first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the coupling tongue 1110 extending therefrom.

The first upper tooth 1410 can be formed monolithically with the first fastener pad 132 of the upper coupling segment 110 at the first end 114 thereof. The first lower tooth 1412 can be formed monolithically with the second fastener pad 134 of the lower coupling segment 112 at the second end 116 thereof. The first fastener pad 132 of the lower coupling segment 112 can define the lower notch 1810 (shown in FIG. 18) and the lower shoulder 1812 (shown in FIG. 18) formed monolithically therewith at the first end 114 thereof. The second fastener pad 134 of the upper coupling segment 110 can define the upper notch 1814 and the upper shoulder 1816 (best seen in FIG. 20) formed monolithically therewith at the second end 116 thereof. In the untightened configuration, the tooth gap 1418 can be defined between the first upper tooth 1410 and the lower shoulder 1812 and between the first lower tooth 1412 and the upper shoulder 1816. In example aspects, the first upper tooth 1410, the first lower tooth 1412, the upper notch 1814, and the lower notch 1810 can be substantially squared off to define a rectangular shape. In other aspects, the first upper tooth 1410, the first lower tooth 1412, the upper notch 1814, and the lower notch 1810 can define any other suitable shape.

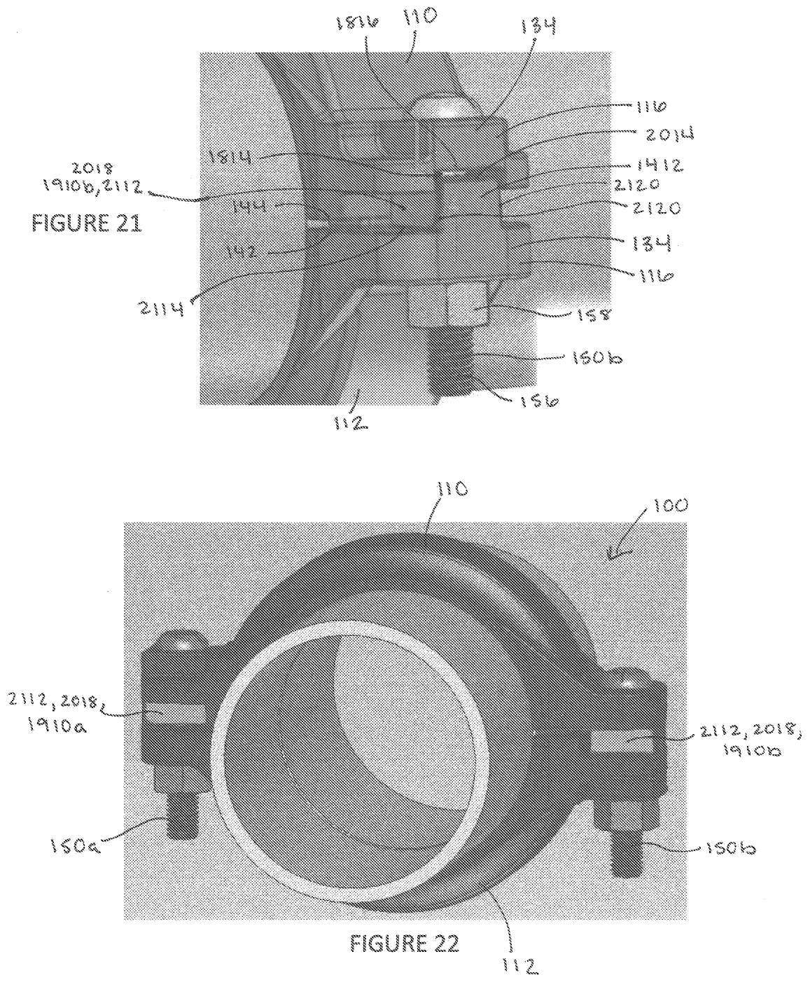

In the present aspect, the first upper tooth 1410 and the first lower tooth 1412 may or may not be considered as part of the first indicator 170a (shown in FIG. 22) and the second indicator 170b, respectively. Each of the first indicator 170a and the second indicator 170b can further comprise a bendable flag 1910 formed separately from the coupling gasket 160 and the coupling body 105. For example, the first indicator 170a can comprise a first bendable flag 1910a (shown in FIG. 22), and the second indicator 170b can comprise a second bendable flag 1910b. Referring to FIG. 20, each bendable flag 1910 can be mounted to the corresponding coupling fastener 150. The bendable flag 1910 can be substantially rectangular and can define a flag opening 2010 through which the bolt shaft 156 of the coupling fastener 150 can extend. The bendable flag 1910 can be substantially planar in the untightened configuration and can define a lower flag surface 2012 and an upper flag surface 2112 (shown in FIG. 21) opposite the lower flag surface 2012. Example aspects of the bendable flags 1910 can comprise a bendable metal material, for example and without limitation. In other aspects, the bendable flags 1910 can comprise any other suitable bendable material. In example aspects, the material and geometry of the bendable flags 1910 can be optimized such that the bendable flags 1910 can be “bistable,” i.e. can be substantially in a state of equilibrium in both the non-bent and bent configurations.

As shown, in the untightened configuration, the lower flag surface 2012 can be visible to an installer. In some example aspects, the color of the lower flag surface 2012, or portions thereof, can be the same color or a similar color to the color of the upper and lower coupling segments 110,112. In some aspects, the color of the lower flag surface 2012 can be a “warning” color, such as red, which is universally associated with caution and hazard. Thus, the visibility of the lower flag surface 2012 may indicate that the corresponding coupling fastener 150 has not been suitably tightened. In other aspects, the lower flag surface 2012 can be orange, yellow, black, or any other suitable color.

The second bendable flag 1910b is illustrated in FIG. 20, which can be substantially the same as the first bendable flag 1910a (shown in FIG. 22). As shown, the second bendable flag 1910b can be mounted on the bolt shaft 156 of the second fastener 150b between the second fastener pads 134 of the upper and lower coupling segments 110,112. A notch portion 2014 of the second bendable flag 1910b can be arranged between the first lower tooth 1412 and the upper notch 1814. Side flap portions 2018 of the second bendable flag 1910b can extend axially outward from opposing axial sides 2016 of the notch portion 2014.

FIG. 21 illustrates the second fastener 150b fully tightened to bend the second bendable flag 1910b to an indicating orientation. The second fastener 150b can be tightened, with the second bendable flag 1910b mounted thereto, by threading the threaded nut 158 along the bolt shaft 156 to draw the second end 116 of the lower coupling segment 112 towards the second end 116 of the upper coupling segment 110. As the second fastener 150b is tightened, the notch portion 2014 of the second bendable flag 1910b can be pushed into the upper notch 1814 by the first lower tooth 1412 and the side flap portions 2018 of the second bendable flag 1910b can be folded over opposing axial tooth sides 2120 of the first lower tooth 1412, as shown. In the tightened configuration, the upper flag surface 2112 of the side flap portions 2018 of the second bendable flag 1910b can be visible between the second fastener pads 134 of the upper coupling segment 110 and the lower coupling segment 112.

In some example aspects, the color of the upper flag surface 2112, or portions thereof, can differ from the color of the lower flag surface 2012 (shown in FIG. 20). Moreover, in some aspects, the color of the upper flag surface 2112, or portions thereof, can be a contrasting color to the color of the upper and lower coupling segments 110,112. In some aspects, the color of the upper flag surface 2112 can be an “affirming” color, such as green, which is universally associated with correctness. Thus, the visibility of the upper flag surface 2112 of the side flap portions 2018 may indicate that the corresponding coupling fastener 150 has been suitably tightened. In other aspects, the upper flag surface 2112 can be white, blue, or any other suitable color.

In some aspects, the second fastener 150b can be tightened until the notch portion 2014 of the second bendable flag 1910b is clamped between the first lower tooth 1412 and the upper shoulder 1816 and/or until the side flap portions 2018 of the second bendable flag 1910b are fully folded to lie against the axial tooth sides 2120 of the first lower tooth 1412. As mentioned, in some aspects, the visibility of the upper flag surface 2112 of the side flap portions 2018 can indicate to an installer that second fastener 150b is suitably tightened. Additionally, in some aspects, manual resistance felt by the installer when the notch portion 2014 of the second bendable flag 1910b is clamped between the first lower tooth 1412 and the upper shoulder 1816 and/or when a distal flag edge 2114 of each side flap portion 2018 is pressed against the lower coupling segment 112 can indicate that the second fastener 150b is suitably tightened. The first lower tooth 1412 and/or the second bendable flag 1910b can also be configured to maintain a desired pad spacing between the primary pad shoulder 142 of the lower coupling segment 112 and the secondary pad shoulder 144 of the upper coupling segment 110 when the second fastener 150b is tightened. As shown in FIG. 22, which illustrates the coupling assembly 100 in the fully tightened configuration, the first fastener 150a can be tightened in the same manner to expose the upper flag surface 2112 of the side flap portions 2018 of the first bendable flag 1910a.

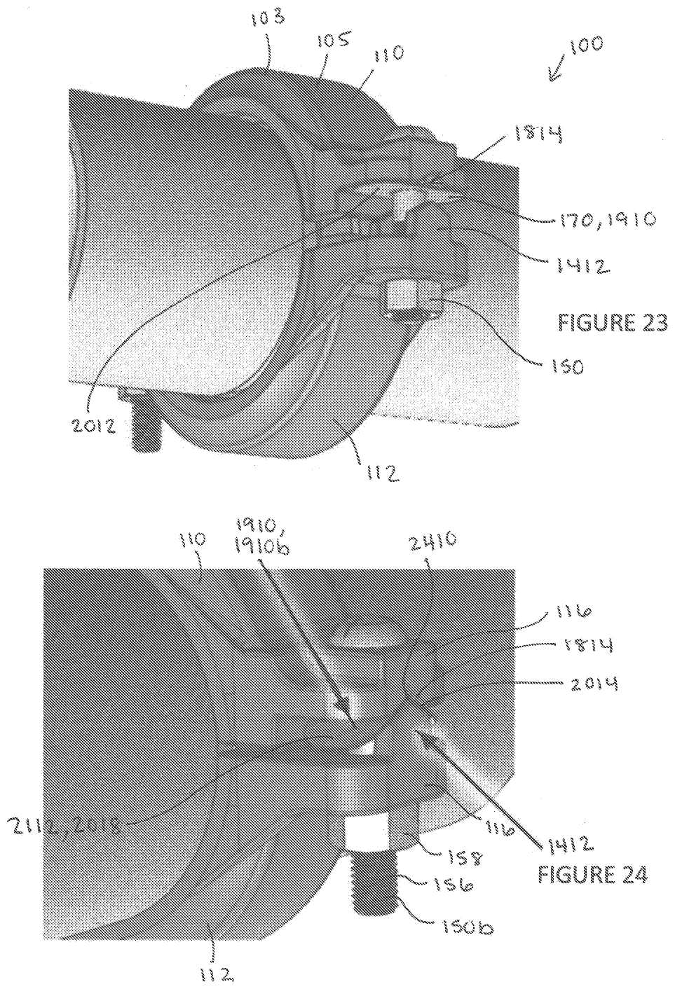

FIG. 23 illustrates a perspective view of the coupling assembly 100 according to another example aspect of the disclosure. The coupling assembly 100 is illustrated in the untightened configuration. The coupling assembly 100 of the present aspect, including the pipe coupling 103 and the at least one installation indicator 170, can be similar to the coupling assembly 100 of FIGS. 19-22 with a few changes. In particular, in the present aspect, the bendable flag(s) 1910 of the installation indicator(s) 170 can be substantially pill-shaped or stadium-shaped. In other aspects, however, the bendable flag 1910 can define any other suitable shape. Additionally, in the present aspect, the first upper tooth 1410 (shown in FIG. 18), the first lower tooth 1412, the upper notch 1814, and the lower notch 1810 (shown in FIG. 18) can be substantially triangular or pointed, as opposed to being squared off. In other aspects, the first upper tooth 1410, the first lower tooth 1412, the upper notch 1814, and/or the lower notch 1810 can define any other suitable shape. In the present aspect, as previously described, the lower flag surface 2012 of the bendable flag 1910 can be similar in color to the color of the upper and lower coupling segments 110,112, and the lower flag surface 2012 can be visible in the untightened configuration. In some aspects, the lower flag surface 2012 of the bendable flag 1910 can be a “warning” color, as previously described, or can be any other suitable color.

FIG. 24 illustrates the second fastener 150b fully tightened to bend the second bendable flag 1910b to the indicating orientation. The second fastener 150b can be tightened, with the second bendable flag 1910b mounted thereto, by threading the threaded nut 158 along the bolt shaft 156 to draw the second end 116 of the lower coupling segment 112 towards the second end 116 of the upper coupling segment 110. As the second fastener 150b is tightened, the notch portion 2014 of the second bendable flag 1910b can be pushed into the upper notch 1814 by the first lower tooth 1412. Due to the pointed shape of the first lower tooth 1412 and the upper notch 1814, the bendable flag 1910 can be folded at a midpoint 2410 of the notch portion 2014, and the side flap portions 2018 of the bendable flag 1910 can be angled downward from the midpoint 2410 and can be exposed external to the lower notch 1810 in the indicating orientation. According to example aspects, the upper flag surface 2112 of the side flap portions 2018 can face outward and be visible to the installer in the indicating orientation, which can indicate to the installer that the second fastener 150b is suitably tightened. As shown, the upper flag surface 2112 can be an “affirming” color as previously described, such as green, or can be any other suitable color.

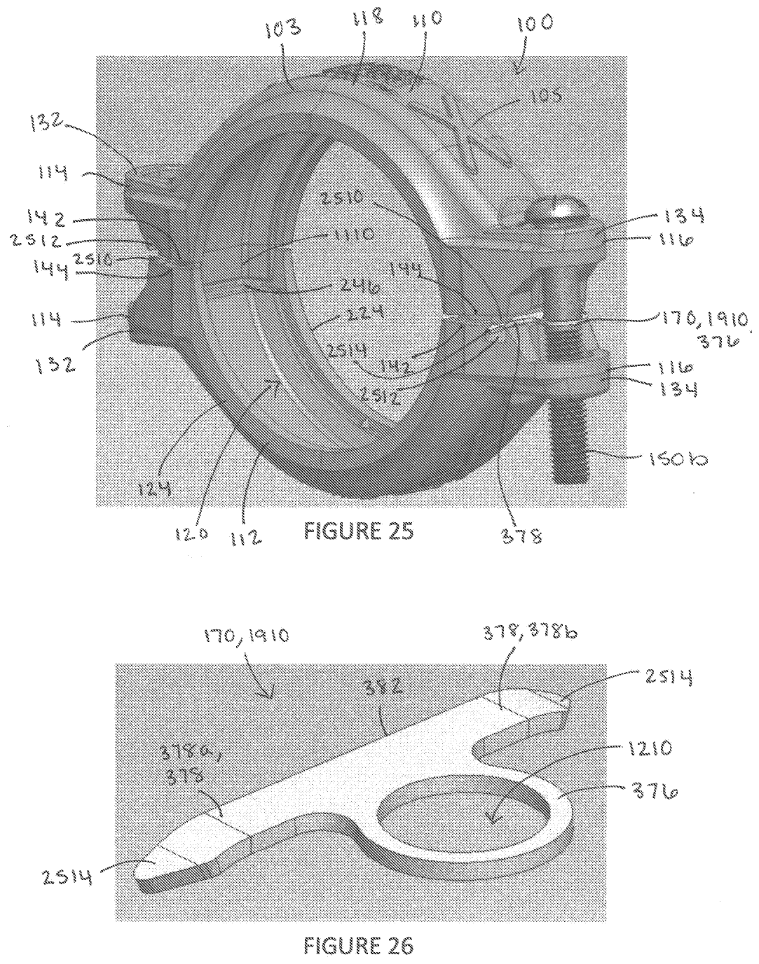

FIG. 25 illustrates a perspective view of the coupling assembly 100 according to another example aspect of the disclosure. The coupling assembly 100 is illustrated in a semi-tightened or tightened configuration. Similar to the previously described coupling assemblies 100, the coupling assembly 100 of the present aspect can comprise the pipe coupling 103 and at least one installation indicator 170. The pipe coupling 103 can comprise the upper coupling segment 110 and the lower coupling segment 112. Example aspects can also comprise the coupling gasket 160 (shown in FIG. 1) disposed within the coupling void 120. Each of the upper and lower coupling segments 110,112 can comprise the first fastener pad 132, the second fastener pad 134, and the substantially arcuate central section 118 therebetween. The opposing central sections 118 can define the coupling void 120 therebetween.

The first fastener 150a (shown in FIG. 1) can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the coupling tongue 1110 extending therefrom, and the second fastener pad 134 of the upper coupling segment 110 can define the secondary pad shoulder 144 and the coupling groove 246 extending into the secondary pad shoulder 144. The first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the coupling tongue 1110 extending therefrom.

At least one installation indicator 170 can be formed separately from the coupling gasket 160 and the coupling body 105, and the at least one installation indicator 170 can be mounted to the corresponding coupling fastener 150. Only one installation indicator 170 is shown in the present view, which can be mounted to the second fastener 150b and arranged between second fastener pads 134 of the upper and lower coupling segments 110,112. According to example aspects, the installation indicator 170 can again be one of the bendable flags 1910. The bendable flag 1910 can comprise a bendable metal material or any other suitable bendable material. In the present aspect, the bendable flag 1910 can be the natural color of the metal material. The bendable flag 1910 can comprise the stem 376 and the pair of flukes 378 to generally define the “whale tail” shape. More specifically, the stem 376 of the installation indicator 170 can be mounted to the second fastener 150b, and the pair of flukes 378 of the installation indicator 170 can be arranged between the secondary pad shoulder 144 of the upper coupling segment 110 and the primary pad shoulder 142 of the lower coupling segment 112. In other aspects, an additional one of the installation indicators 170 can be mounted to the first fastener 150a and arranged between the first fastener pads 132 of the upper and lower coupling segments 110,112.

According to example aspects, the second fastener pad 134 of the upper coupling segment 110 can define a pair of flag tabs 2510, and the second fastener pad 134 of the lower coupling segment 112 can define a pair of flag notches 2512. For example, the pair of flag tabs 2510 can extend downward from the secondary pad shoulder 144 of the upper coupling segment 110 towards the lower coupling segment 112, relative to the orientation shown. The pair of flag notches 2512 can extend downwardly into the primary pad shoulder 142 of the lower coupling segment 112, relative to the orientation shown. Each of the flag tabs 2510 can be aligned with a corresponding one of the flag notches 2512, with one aligned pair of the flag tab 2510 and the flag notch 2512 arranged proximate to the axially front end 124 of the coupling assembly 100 and another aligned pair of the flag tab 2510 and the flag notch 2512 arranged proximate to the axially rear end 224. A distal fluke end 2514 of each of the flukes 378 of the bendable flag 1910 can be arranged between a corresponding pair of the flag tabs 2510 and flag notches 2512. Additionally, as shown, the first fastener pad 132 of the lower coupling segment 112 can define a pair of the flag tabs 2510, and the first fastener pad 132 of the upper coupling segment 110 can define a pair of the flag notches 2512

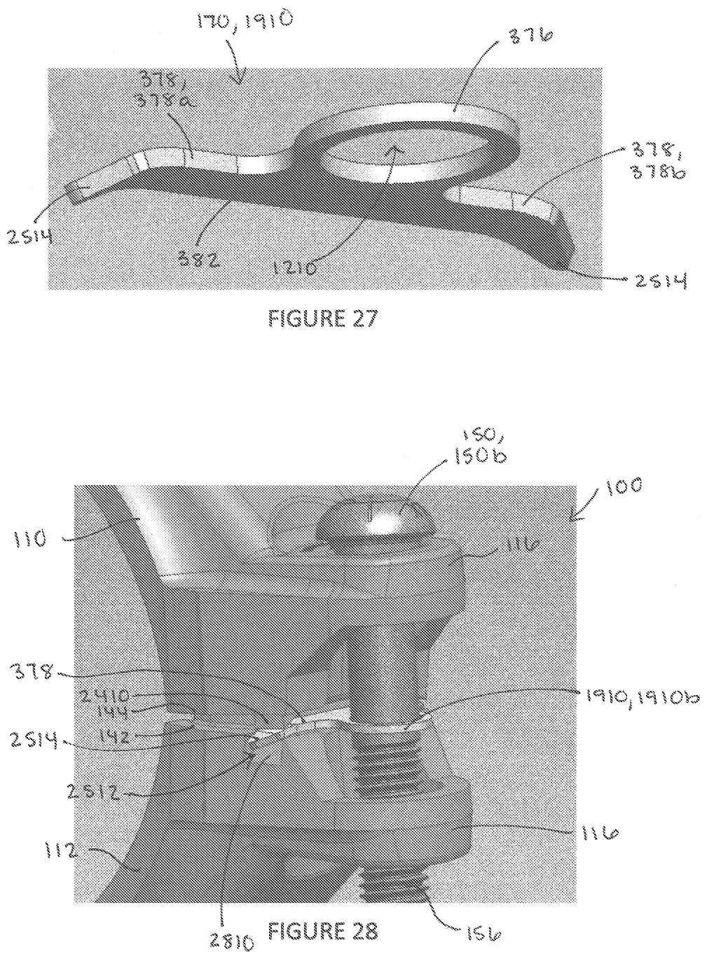

FIGS. 26 and 27 illustrate top and bottom perspective view of the installation indicator 170, which can be the “whale tail”-style bendable flag 1910. The bendable flag 1910 can comprise the stem 376 and the pair of flukes 378. Each of the first fluke 378a and the second fluke 378b can be oriented substantially perpendicular to the stem 376. In some aspects, the distal fluke end 2514 of each of the flukes 378 may be pre-bent slightly relative to the stem 376 in the untightened configuration. In other aspects, the pair of flukes 378 can be substantially coplanar with the stem 376 in the untightened configuration. As shown, the stem 376 can be substantially annular in shape and can define the bolt opening 1210 therethrough for receiving the bolt shaft 156 (shown in FIG. 25) of the corresponding coupling fastener 150 (shown in FIG. 25). The bendable flag 1910 does not comprise the fluke notch 380 (shown in FIG. 3) between the first fluke 378a and the second fluke 378b at the distal indicator end 382, such that the pair of flukes 378 could be said to together define one continuous fluke 378 in the present aspect (e.g., the bendable flag 1910 can be substantially T-shaped).

FIG. 28 illustrates a detail end view of the coupling assembly 100, wherein the second fastener 150b is partially tightened to the semi-tightened or tightened configuration. The second fastener 150b can be tightened, with the second bendable flag 1910b mounted thereto, by threading the threaded nut 158 (shown in FIG. 1) along the bolt shaft 156 to draw the second end 116 of the lower coupling segment 112 towards the second end 116 of the upper coupling segment 110. As the second fastener 150b is tightened, the distal fluke end 2514 of each of the flukes 378 can be pushed into the corresponding flag notch 2512 by the corresponding flag tab 2410, thereby bending the distal fluke ends 2514 to the indicating orientation. In the indicating orientation, the distal fluke ends 2514 can be folded towards a ramped notch surface 2810 of the corresponding flag notch 2512.

In some aspects, as shown, the increased visibility of the distal fluke end 2514 as it is folded into the corresponding flag notch 2512 can indicate to an installer than the coupling fastener 150 is suitably tightened. In some aspects, the coupling fastener 150 can be tightened until the distal fluke end 2514 is substantially clamped between the flag tab 2510 and the ramped notch surface 2810 of the flag notch 2512, and the resistance felt by the installer can indicate to the installer that the coupling fastener 150 is suitably tightened. Additionally, in example aspects, the arrangement of the flukes 378 between the primary pad shoulder 142 of the lower coupling segment 112 and the secondary pad shoulder 144 of the upper coupling segment 110 can maintain a desired pad spacing between the primary pad shoulder 142 and the secondary pad shoulder 144 when the second fastener 150b is tightened. The first fastener 150a (shown in FIG. 1) can be tightened in the same manner to configure the coupling assembly 100 in the fully tightened configuration.

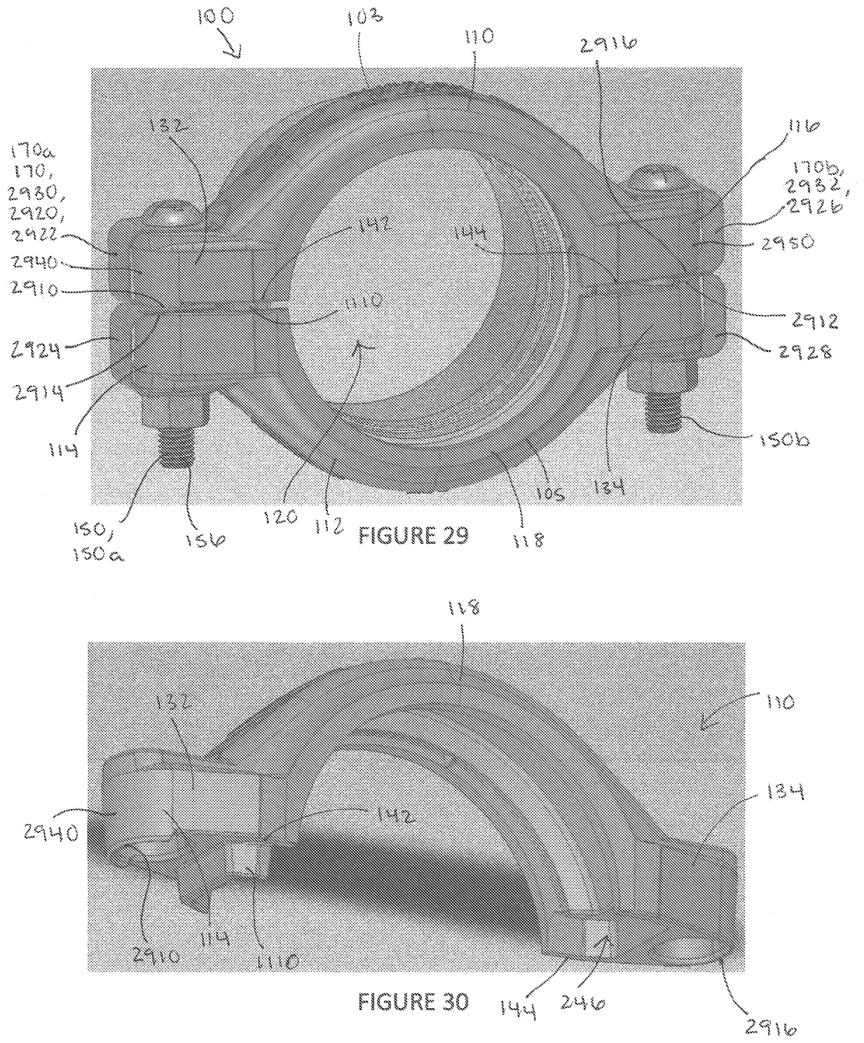

FIG. 29 illustrates a perspective view of the coupling assembly 100 according to another example aspect of the disclosure, and FIG. 30 illustrates the upper coupling segment 110 of the coupling assembly 100, which can be substantially the same as the lower coupling segment 112. The coupling assembly 100 is illustrated in the untightened configuration in FIG. 29. Similar to the previously described coupling assemblies 100, the coupling assembly 100 of the present aspect can comprise the pipe coupling 103 and at least one installation indicator 170. The pipe coupling 103 can comprise the upper coupling segment 110 and the lower coupling segment 112. In example aspects, the coupling gasket 160 (shown in FIG. 1) can be disposed within the coupling void 120. Each of the upper and lower coupling segments 110,112 can comprise the first fastener pad 132, the second fastener pad 134, and the substantially arcuate central section 118 extending therebetween. The opposing central sections 118 can define the coupling void 120 therebetween.

The first fastener 150a can couple the first fastener pad 132 of the upper coupling segment 110 to the first fastener pad 132 of the lower coupling segment 112 at the first ends 114 thereof. The second fastener 150b can couple the second fastener pad 134 of the upper coupling segment 110 to the second fastener pad 134 of the lower coupling segment 112 at the second ends 116 thereof. The first fastener pad 132 of the upper coupling segment 110 can define the primary pad shoulder 142 and the coupling tongue 1110 extending therefrom, and the second fastener pad 134 of the upper coupling segment 110 can define the secondary pad shoulder 144 and the coupling groove 246 (shown in FIG. 30) extending into the secondary pad shoulder 144. Conversely, the first fastener pad 132 of the lower coupling segment 112 can define the secondary pad shoulder 144 and the coupling groove 246 extending into the secondary pad shoulder 144, and the second fastener pad 134 of the lower coupling segment 112 can define the primary pad shoulder 142 and the coupling tongue 1110 extending therefrom.

In the present aspect, a first cutting rib 2910 can be formed monolithically with the first fastener pad 132 of the upper coupling segment 110 at the first end 114 thereof, and a second cutting rib 2912 can be formed monolithically with the second fastener pad 134 of the lower coupling segment 112 at the second end 116 thereof. The first cutting rib 2910 can extend downward towards the lower coupling segment 112, and the second cutting rib 2912 can extend upward towards the upper coupling segment 110, relative to the orientation shown. Moreover, the first fastener pad 132 of the lower coupling segment 112 can define a first cutting platform 2914 at the first end 114 thereof, and the second fastener pad 134 of the upper coupling segment 110 can define a second cutting platform 2916 at the second end 116 thereof.

In example aspects, each of the first indicator 170a and the second indicator 170b can comprise one or more cuttable flags 2920 formed separately from the coupling gasket 160 and the coupling body 105. Example aspects of the cuttable flags 2920 can comprise a cuttable material that can be cut by the first cutting rib 2910 and the second cutting rib 2912, as described in further detail below. The cuttable material can be, for example and without limitations, a polymer, an elastomer, a metal material, or the like, or can be any suitable combination of materials. Moreover, in some aspects, the cuttable flags 2920 can be a bright color and/or can be a contrasting color to the color of the upper and lower coupling segments 110,112, which can make the cuttable flags 2920 easily visible to an installer. For example and without limitation, in the present aspect, the cuttable flags 2920 can be green, while the upper and lower coupling segments 110,112 can be orange. In other aspects, the cuttable flags 2920 and/or the upper and lower coupling segments 110,112 can be any other suitable color or colors.

In the present aspect, the first indicator 170a can comprise a first upper cuttable flag 2922 and a first lower cuttable flag 2924, and the second indicator 170b can comprise a second upper cuttable flag 2926 and a second lower cuttable flag 2928. In some aspects, the first upper cuttable flag 2922 and the first lower cuttable flag 2924 can be monolithically formed to define a substantially E-shaped first cuttable flag 2930, as shown. Similarly, in some aspects, the second upper cuttable flag 2926 and the second lower cuttable flag 2928 can be monolithically formed to define a substantially E-shaped second cuttable flag 2932, as shown. In other aspects, each of the first upper, first lower, second upper, and second lower cuttable flags 2922,2924,29262928 can be independently formed as a substantially C-shaped cuttable flag 3210 (shown in FIG. 32). In example aspects, the first indicator 170a and/or second indicator 170b can comprise two of the substantially C-shaped cuttable flags 3210 (e.g., both of the first upper cuttable flag 2922 and the first lower cuttable flag 2924 and/or both of the second upper cuttable flag 2926 and the second lower cuttable flag 2928) or can comprise only one of the C-shaped cuttable flags 3210 (e.g., either the first upper cuttable flag 2922 or the first lower cuttable flag 2924 and/or either the second upper cuttable flag 2926 or the second lower cuttable flag 2928).

Each of the first upper cuttable flag 2922 and the first lower cuttable flag 2924 can be mounted to the first fastener 150a proximate to the first fastener pads 132 of the upper coupling segment 110 and the lower coupling segment 112. The first upper cuttable flag 2922 can be configured to wrap around the first fastener pad 132 the upper coupling segment 110 at a first outer end 2940 thereof, and the first lower cuttable flag 2924 can be configured to wrap around the first fastener pad 132 of the lower coupling segment 112 at the corresponding first outer end 2940 thereof. Similarly, each of the second upper cuttable flag 2926 and the second lower cuttable flag 2928 can be mounted to the second fastener 150b proximate to the second fastener pads 134 of the upper coupling segment 110 and the lower coupling segment 112. The second upper cuttable flag 2926 can be configured to wrap around the second fastener pad 134 of the upper coupling segment 110 at a second outer end 2942 thereof, and the second lower cuttable flag 2928 can be configured to wrap around the second fastener pad 134 of the lower coupling segment 112 at the corresponding second outer end 2942 thereof.

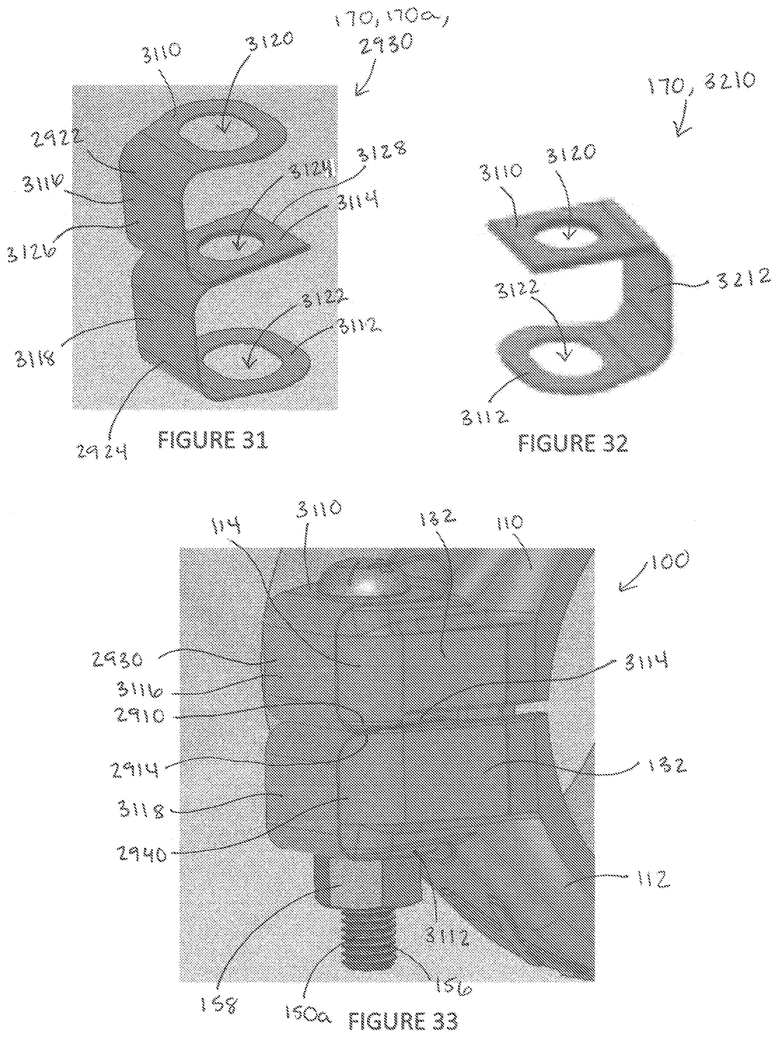

FIG. 31 illustrates a perspective view of the substantially E-shaped first cuttable flag 2930, which can be the same or about the same as the substantially E-shaped second cuttable flag 2932 (shown in FIG. 29). As shown, the substantially E-shaped first cuttable flag 2930 can comprise the first upper cuttable flag 2922 monolithically formed with the first lower cuttable flag 2924. The first upper cuttable flag 2922 can define an upper end wall 3110, and the first lower cuttable flag 2924 can define a lower end wall 3112 opposite from and substantially parallel to the upper end wall 3110. The first upper cuttable flag 2922 and the first lower cuttable flag 2924 can together define a middle wall 3114 disposed between and substantially parallel to the upper end wall 3110 and the lower end wall 3112. As shown, an upper opening 3120 can be formed through the upper end wall 3110, a middle opening 3124 can be formed through the middle wall 3114, and a lower opening 3122 can be formed through the lower end wall 3112. The bolt shaft 156 (shown in FIG. 29) of the first fastener 150a (shown in FIG. 29) can be configured to extend through each of the upper opening 3120, the middle opening 3124, and the lower opening 3122. The substantially E-shaped first cuttable flag 2930 can define a first side 3126 and an opposite second side 3128. Example aspects of the first cuttable flag 2930 can further define an upper sidewall 3116 extending between the upper end wall 3110 and the middle wall 3114 at the first side 3126 and a lower sidewall 3118 extending between the middle wall 3114 and the lower end wall 3112 at the first side 3126.

FIG. 32 illustrates an example aspect of one of the substantially C-shaped cuttable flags 3210 (such as, for example, the independently formed first upper, first lower, second upper, and second lower cuttable flags 2922,2924,29262928, each shown in FIG. 29). As shown, the substantially C-shaped cuttable flag 3210 can comprise the upper end wall 3110 and the lower end wall 3112 parallel to the upper end wall 3110, but does not comprise middle wall 3114 (shown in FIG. 31). The upper opening 3120 can be formed through the upper end wall 3110, and the lower opening 3122 can be formed through the lower end wall 3112. The bolt shaft 156 (shown in FIG. 29) of the corresponding coupling fastener 150 (shown in FIG. 29) can extend through the upper opening 3120 and the lower opening 3122. A flag sidewall 3212 can extend between the upper end wall 3110 and the lower end wall 3112. In some aspects, only one of the C-shaped cuttable flags 3210 can be mounted to each corresponding coupling fastener 150. In other aspects, a pair of the C-shaped cuttable flags 3210 can be mounted to each of the corresponding coupling fasteners 150.

Referring now to the end perspective view of FIG. 33, the substantially E-shaped first cuttable flag 2930 is shown mounted to the first fastener 150a. As shown, the first cuttable flag 2930 can comprise the upper end wall 3110, the lower end wall 3112, and the middle wall 3114 therebetween. The upper sidewall 3116 can extend between the upper end wall 3110 and the middle wall 3114, and the lower sidewall 3118 can extend between the middle wall 3114 and the lower end wall 3112. The upper sidewall 3116 of the first cuttable flag 2930 can extend along the first outer end 2940 of the upper coupling segment 110, and the lower sidewall 3118 of the first cuttable flag 2930 can extend along the first outer end 2940 of the lower coupling segment 112 in the untightened configuration. Additionally, the middle wall 3114 can be disposed between the first fastener pad 132 of the upper coupling segment 110 and the first fastener pad 132 of the lower coupling segment 112, as illustrated.

The first fastener 150a can be tightened, with the substantially E-shaped first cuttable flag 2930 mounted thereto, by threading the threaded nut 158 along the bolt shaft 156 to draw the first end 114 of the lower coupling segment 112 towards the first end 114 of the upper coupling segment 110. In some aspects, the first fastener pad 132 of the upper coupling segment 110 and the first fastener pad 132 of the lower coupling segment 112 can deform towards one another as the first fastener 150a is tightened. As the first fastener 150a is tightened and the first fastener pads 132 of the upper and lower coupling segments 110,112 deform towards one another, the first cutting platform 2914 of the lower coupling segment 112 can press the middle wall 3114 of the first cuttable flag 2930 upwards against the first cutting rib 2910 formed monolithically with the upper coupling segment 110. The middle wall 3114 can be crushed between the first cutting platform 2914 and the first cutting rib 2910, and the first cutting rib 2910 can sever the middle wall 3114. In other aspects, the first cutting rib 2910 and the first cutting platform 2914 can define overlapping surfaces that can apply a shearing force to the middle wall 3114, instead of a crushing force, to sever the middle wall 3114.

Once the middle wall 3114 has been severed, the upper sidewall 3116 and the lower sidewall 3118 of the substantially E-shaped first cuttable flag 2930 can pop outwards from the first outer ends 2940 of the upper and lower coupling segments 110,112. When the upper sidewall 3116 and the lower sidewall 3118 pop outwards from the upper and lower coupling segments 110,112, the upper and lower sidewalls 3116,3118 can become significantly more visible to the installer, which can indicate to the installer that the first fastener 150a has been suitably tightened. The second fastener 150b (shown in FIG. 29) can then be tightened in the same manner to configure the coupling assembly 100 in the fully tightened configuration.

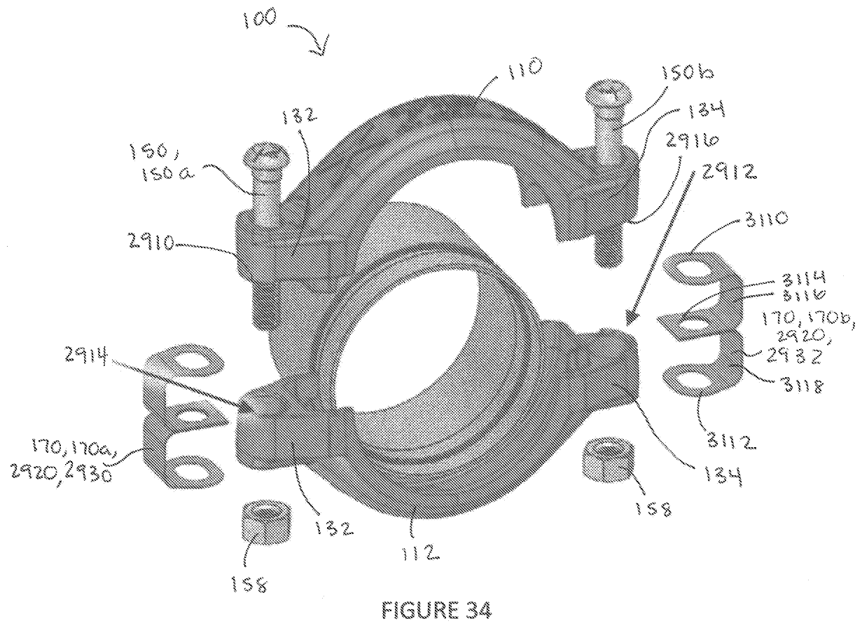

FIG. 34 illustrates an exploded view of the coupling assembly 100 comprising the substantially E-shaped first cuttable flag 2930 and the substantially E-shaped second cuttable flag 2932.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A pipe coupling comprising:
a coupling body comprising a first coupling segment and a second coupling segment, each of the first and second coupling segments defining a first end and a second end opposite the first end;
a fastener mounted to the coupling body and configured to tighten the pipe coupling from an untightened configuration to a tightened configuration; and
an installation indicator arranged between the first end of the first coupling segment and the first end of the second coupling segment, wherein the installation indicator is clamped between the first and second coupling segments in the tightened configuration.

2. A pipe coupling comprising:
a coupling body comprising a first coupling segment and a second coupling segment, each of the first and second coupling segments defining a first end and a second end opposite the first end, wherein;
a first indicator element is formed monolithically with the first coupling segment at the first end of the first coupling segment; and
a second indicator element is formed monolithically with the second coupling segment at the first end of the second coupling segment; and
a fastener mounted to the coupling body and configured to tighten the pipe coupling from an untightened configuration to a tightened configuration, wherein the first indicator element is pressed against the second indicator element in the tightened configuration.
